(19) United States
(12) Patent Application Publication
(10) Pub. No.: US 2011/0004564 A1
(43) Pub. Date: Jan. 6, 2011

(54) Model Based Deployment Of Computer Based Business Process On Dedicated Hardware

(76) Inventors: Jerome Rolia, Kanata (CA); Nigel Edwards, Bristol (GB); Guillaume Alexandre Belrose, Marlborough (GB); Sven Graupner, Mountain View, CA (US); Lawrence Wilcock, Malmesbury Wiltshire (GB); Bryan Stephenson, Alviso, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/808,229

(22) PCT Filed: Dec. 20, 2007
(86) PCT No.: PCT/US07/88336

§ 371 Date: Sep. 17, 2010

(51) Int. Cl. G06Q 10/00

(52) U.S. Cl. 705/348

(57) ABSTRACT

A method of automated deployment managed by a service provider, of a computer based business process, involves generating a model (730) of the business process including a design of computing infrastructure, and deploying the model on hardware (770) dedicated to the enterprise, with an interface for the service provider to enable ongoing management of the deployed process by the service provider. Having dedicated hardware means the location of the hardware can be arranged to suit the enterprise. This means limitations such as bandwidth or latency of WAN links, can be addressed by choosing the location of the dedicated hardware appropriately. Trust of security can also be increased compared to that of the shared data centres. The automated model driven deployment can help enable the service provider to provide such deployments on different types of hardware. The need for the enterprise to maintain specialist expertise in house is reduced.

This application relates to copending U.S. applications titled “SETTING UP DEVELOPMENT ENVIRONMENT FOR COMPUTER BASED BUSINESS PROCESS” (applicant reference number 200702145), titled “VISUAL INTERFACE FOR SYSTEM FOR DEPLOYING COMPUTER BASED PROCESS ON SHARED INFRASTRUCTURE” (applicant reference number 200702356), titled “MODELING COMPUTER BASED BUSINESS PROCESS FOR CUSTOMISATION AND DELIVERY” (applicant reference number 200702363), titled “MODELING COMPUTER BASED BUSINESS PROCESS AND SIMULATING OPERATION” (applicant reference number 200702377), titled “AUTOMATED MODEL GENERATION FOR COMPUTER BASED BUSINESS PROCESS”, (applicant reference number 200702600), and titled “INCORPORATING DEVELOPMENT TOOLS IN SYSTEM FOR DEPLOYING COMPUTER BASED PROCESS ON SHARED INFRASTRUCTURE”, and previously filed US application titled “DERIVING GROUNDED MODEL OF BUSINESS PROCESS SUITABLE FOR AUTOMATIC DEPLOYMENT” (Ser. No. 11/741878) all of which are hereby incorporated by reference in their entirety.

### FIELD OF THE INVENTION

The invention relates to methods of automated deployment managed by a service provider, of a computer based business process, and relates to corresponding systems and software.

### BACKGROUND

Physical IT (information technology) infrastructures are difficult to manage. Changing the network configuration, adding a new machine or storage device are typically complicated and error prone manual tasks. In most physical IT infrastructure, resource utilization is very low: 15% is not an uncommon utilization for a server, 5% for a desktop. To address this, modern computer infrastructures are becoming increasingly (re)-configurable and more use is made of shared infrastructure in the form of data centres provided by service providers.

Hewlett Packard's UDC (Utility Data Centre) is an example which has been applied commercially and allows automatic reconfiguration of physical infrastructure: processing machines such as servers, storage devices such as disks, and networks coupling the parts. Reconfiguration can involve moving or starting software applications, changing allocations of storage space, or changing allocation of processing time to different processes for example. Another way of contributing more reconfigurability, is by allowing many “virtual” computers to be hosted on a single physical machine. The term “virtual” usually means the opposite of real or physical, and is used where there is a level of indirection, or some mediation between the resource user and the physical resource.

In addition some modern computing fabrics allow the underlying hardware to be reconfigured. In once instance the fabric might be configured to provide a number of four-way computers. In another instance it might be re-configured to provide four times as many single processor computers.

It is extremely complex to model the full reconfigurability of the above. Models of higher level entities need to be recursive in the sense of containing or referring to lower level entities used or required to implement them (for example a virtual machine VM, may operate faster or slower depending on what underlying infrastructure is currently used to implement it (for example hardware partition nPAR or virtual partition vPAR, as will be described in more detail below). This means a model needs to expose the underlying configurability of the next generation computer fabrics—an nPAR consists of a particular hardware partition. This makes the models so complex that it becomes increasingly difficult for automated tools (and humans) to understand and process the models, to enable design and management of: a) the business process, b) the application and application configuration, and c) the infrastructure and infrastructure configuration.

The need to model the full reconfigurability and recursive nature of a system is exemplified in the DMTF's profile for “System Virtualization, Partitioning and Clustering”: http://www.dmtf.org/apps/org/workgroup/redundancy/

Another example of difficulties in modeling is WO2004090684 which relates to modeling systems in order to perform processing functions. It says “The potentially large number of components may render the approach impractical. For example, an IT system with all of its hardware components, hosts, switches, routers, desktops, operating systems, applications, business processes, etc. may include millions of objects. It may be difficult to employ any manual or automated method to create a monolithic model of such a large number of components and their relationships. This problem is compounded by the typical dynamic nature of IT systems having frequent adds/moves/changes. Secondly, there is no abstraction or hiding of details, to allow a processing function to focus on the details of a particular set of relevant components while hiding less relevant component details. Thirdly, it may be impractical to perform any processing on the overall system because of the number of components involved.”

There have been attempts to automatically and rapidly provide computing infrastructures: HP's Utility Data Center, HP Lab's SoftUDC, HP's Caveo and Amazon's Elastic Compute Cloud (which can be seen at http://www.amazon.com/gp/browse.html?node=201590011). All of these provide computing infrastructures of one form or another, and some have been targeted at testers and developers, e.g. HP's Utility Data Center.

Aris from IDS-Scheer is a known business process modeling platform having a model repository containing information on the structure and intended behaviour of the system. In particular, the business processes are modeled in detail. It is intended to tie together all aspects of system implementation and documentation.

Aris UML designer is a component of the Aris platform, which combines conventional business process modeling with software development to develop business applications from process analysis to system design. Users access process model data and UML content via a Web browser, thereby enabling processing and change management within a multi-user environment. It can provide for creation and communication of development documentation, and can link object-oriented design and code generation (CASE tools). It relies on human entry of the models.

### SUMMARY OF THE INVENTION

An object is to provide improved apparatus or methods. In one aspect the invention provides:

a method of automated deployment managed by a service provider, of a computer based business process having a number of functional steps, for a given enterprise, the method having the steps of:

generating a model of the business process, the model having a representation of an arrangement of software application components, for implementing the functional steps, and having a representation of computing infrastructure, for running the software application components on specified enterprise dedicated hardware, and suitable for automated deployment, to meet given non functional requirements if there are any, and

deploying the model on the hardware dedicated to the enterprise, with an interface for the service provider to enable ongoing management of the deployed process by the service provider.

By giving the enterprise dedicated hardware rather than using shared hardware as in a conventional data centre, the service provider can offer a combination of some of the advantages of in house services with advantages of out sourced service provision. For example the enterprise can reduce or control some of the limitations of having to use shared hardware in centralised data centres. For example, having dedicated hardware means the location of the hardware can be arranged to suit the enterprise. This means limitations such as bandwidth or latency of WAN links, can be addressed by choosing the location of the dedicated hardware to be on or near the enterprises premises. Having dedicated hardware can also increase trust of security compared to that of the shared data centres. This can be addressed for example, by the enterprise having control of physical access to the dedicated hardware and data for example. These benefits are facilitated by the automated model driven deployment, which can help enable the service provider to provide such deployments on different types of hardware with less need for skilled personnel and can reduce the need for the hardware to be centrally located. This also reduces the need for the enterprise to maintain specialist expertise in house. The service provider can also benefit by reducing the load (in terms of computing and power consumption) on resources in a shared data centre by distributing some of the load onto hardware that operates outside the service provider's data centre.

Embodiments of the invention can have any additional features, without departing from the scope of the claims, and some such additional features are set out in dependent claims and in embodiments described below.

Another aspect provides software on a machine readable medium which when executed carries out the above method.

Another aspect provides a system, for automated deployment managed by a service provider, of a computer based business process having a number of functional steps, for a given enterprise, the system having:

a model generation part arranged to generate a model of the process, the model having a representation of an arrangement of software application components, for implementing the functional steps, and having a representation of computing infrastructure, for running the software application components on the enterprise dedicated hardware, and suitable for automated deployment, to meet given non functional requirements if there are any, and

a deployment part arranged to provide automated deployment of the model on the hardware dedicated to the enterprise, with an interface for the service provider to enable ongoing management of the deployed process by the service provider.

Other aspects can encompass corresponding steps by human operators using the system, to enable direct infringement or inducing of direct infringement in cases where the infringers system is partly or largely located remotely and outside the jurisdiction covered by the patent, as is feasible with many such systems, yet the human operator is using the system and gaining the benefit, from within the jurisdiction. Other advantages will be apparent to those skilled in the art, particularly over other prior art. Any of the additional features can be combined together, and combined with any of the aspects, as would be apparent to those skilled in the art. The embodiments are examples only, the scope is not limited by these examples, and many other examples can be conceived within the scope of the claims.

### BRIEF DESCRIPTION OF THE FIGURES

Specific embodiments of the invention will now be described, by way of example, with reference to the accompanying Figures, in which:

FIG. 1 shows a schematic view of an embodiment showing models, adaptive infrastructure and a management system,

FIG. 2 shows a schematic view of some operation steps by an operator and by the management system, according to an embodiment,

FIG. 3 shows a schematic view of some of the principal actions and models according to an embodiment,

FIG. 4 shows a schematic view of a sequence of steps from business process to deployed model in the form of a model information flow, MIF, according to another embodiment,

FIG. 5 shows a sequence of steps and models according to another embodiment,

FIG. 6 shows steps in deriving a grounded model according to an embodiment,

FIG. 7 shows an arrangement of master and slave application servers for a distributed design, according to an embodiment,

FIG. 8 shows parts of a master application server for the embodiment of FIG. 7,

FIG. 9 shows an arrangement of virtual entities on a server, for use in an embodiment,

FIG. 10 shows an example of a sales and distribution business process (SD) Benchmark Dialog Steps and Transactions,

FIG. 11 shows an example Custom Model Instance for SD Benchmark,

FIG. 12 shows a class diagram for an Unbound Model Class,

FIG. 13 shows an example of a template suitable for a decentralised SD example,

FIG. 14 shows a Grounded Model instance for a decentralized SD,

FIG. 15 shows another example of a template, suitable for a centralised secure SD example,

FIG. 16 shows an embodiment of a system for deployment on enterprise dedicated hardware,

FIGS. 17, 18, 19 and 20 show steps according to embodiments, and

FIG. 21 shows a system according to another embodiment.

### DESCRIPTION OF SPECIFIC EMBODIMENTS

### Definitions

“enterprise dedicated hardware” encompasses hardware such as physical servers, storage and communications links which is for the exclusive use of that enterprise and thus its location can be chosen by the enterprise. It need not be owned by the enterprise, it can be leased or paid for in any way as part of the cost of the service. It cannot be reallocated or removed except with the permission of the enterprise. Constituent components and identifiers of the parts of the hardware can generally be changed by the service provider to meet the needs of the enterprise. The enterprise may permit the service provider to allow other enterprises to make use of spare capacity on a temporary basis.

“non-functional requirements” can encompass how well the functional steps are achieved, in terms such as performance, security properties, cost, availability and others. It is explained in Wikipedia (http://en.wikipedia.org/wiki/Non-functional_requirements) for non-functional requirements as follows—“In systems engineering and requirements engineering, non-functional requirements are requirements which specify criteria that can be used to judge the operation of a system, rather than specific behaviors. This should be contrasted with functional requirements that specify specific behavior or functions. Typical non-functional requirements are reliability, scalability, and cost. Non-functional requirements are often called the ilities of a system. Other terms for non-functional requirements are “constraints”, “quality attributes” and “quality of service requirements”.”

“Functional steps” can encompass any type of function of the business process, for any purpose, such as interacting with an operator receiving inputs, retrieving stored data, processing data, passing data or commands to other entities, and so on, typically but not necessarily, expressed in human readable form.

“Deployed” is intended to encompass a modeled business process for which the computing infrastructure has been allocated and configured, and the software application components have been installed and configured ready to become operational. According to the context it can also encompass a business process which has started running.

“suitable for automated deployment” can encompass models which provide machine readable information to enable the infrastructure design to be deployed, and to enable the software application components to be installed and configured by a deployment service, either autonomously or with some human input guided by the deployment service.

“business process” is intended to encompass any process involving computer implemented steps and optionally other steps such as human input or input from a sensor or monitor for example, for any type of business purpose such as service oriented applications, for sales and distribution, inventory control, control or scheduling of manufacturing processes for example. It can also encompass any other process involving computer implemented steps for non business applications such as educational tools, entertainment applications, scientific applications, any type of information processing including batch processing, grid computing, and so on. One or more business process steps can be combined in sequences, loops, recursions and branches to form a complete Business Process. Business process can also encompass business administration processes such as CRM, sales support, inventory management, budgeting, production scheduling and so on, and any other process for commercial or scientific purposes such as modeling climate, modeling structures, or modeling nuclear reactions.

“application components” is intended to encompass any type of software element such as modules, subroutines, code of any amount usable individually or in combinations to implement the computer implemented steps of the business process. It can be data or code that can be manipulated to deliver a business process step (BPStep) such as a transaction or a database table. The Sales and Distribution (SD) product produced by SAP is made up of a number of transactions each having a number of application components for example.

“unbound model” is intended to encompass software specifying in any way, directly or indirectly, at least the application components to be used for each of the computer implemented steps of the business process, without a complete design of the computing infrastructure, and may optionally be used to calculate infrastructure resource demands of the business process, and may optionally be spread across or consist of two or more sub-models. The unbound model can also specify the types or versions of corresponding execution components such as application servers and database servers, needed by each application component, without specifying how many of these are needed for example.

“grounded model” is intended to encompass software specifying in any way, directly or indirectly, at least a complete design of the computing infrastructure suitable for automatic deployment of the business process. It can be a complete specification of a computing infrastructure and the application components to be deployed on the infrastructure.

“bound model” encompasses any model having a binding of the Grounded Model to physical resources. The binding can be in the form of associations between ComputerSystems, Disks, StorageSystems, Networks, NICS that are in the Grounded Model to real physical parts that are available in the actual computing infrastructure.

“infrastructure design template” is intended to encompass software of any type which determines design choices by indicating in any way at least some parts of the computing infrastructure, and indicating predetermined relationships between the parts. This will leave a limited number of options to be completed, to create a grounded model. These templates can indicate an allowable range of choices or an allowable range of changes for example. They can determine design choices by having instructions for how to create the grounded model, or how to change an existing grounded model.

“computing infrastructure” is intended to encompass any type of resource such as hardware and software for processing, for storage such as disks or chip memory, and for communications such as networking, and including for example servers, operating systems, virtual entities, and management infrastructure such as monitors, for monitoring hardware, software and applications. All of these can be “designed” in the sense of configuring and/or allocating resources such as processing time or processor hardware configuration or operating system configuration or disk space, and instantiating software or links between the various resources for example. The resources may or may not be shared between multiple business processes. The configuring or allocating of resources can also encompass changing existing configurations or allocations of resources. Computing infrastructure can encompass all physical entities or all virtualized entities, or a mixture of virtualized entities, physical entities for hosting the virtualized entities and physical entities for running the software application components without a virtualized layer.“parts of the computing infrastructure” is intended to encompass parts such as servers, disks, networking hardware and software for example.

“server” can mean a hardware processor for running application software such as services available to external clients, or a software element forming a virtual server able to be hosted by a hosting entity such as another server, and ultimately hosted by a hardware processor.

“AIService” is an information service that users consume. It implements a business process.

“Application Constraints Model” can mean arbitrary constraints on components in the Customized Process, Application Packaging and Component Performance Models. These constraints can be used by tools to generate additional models as the MIF progresses from left to right.

“ApplicationExecutionComponent” is for example a (worker) process, thread or servlet that executes an Application component. An example would be a Dialog Work Process, as provided by SAP.

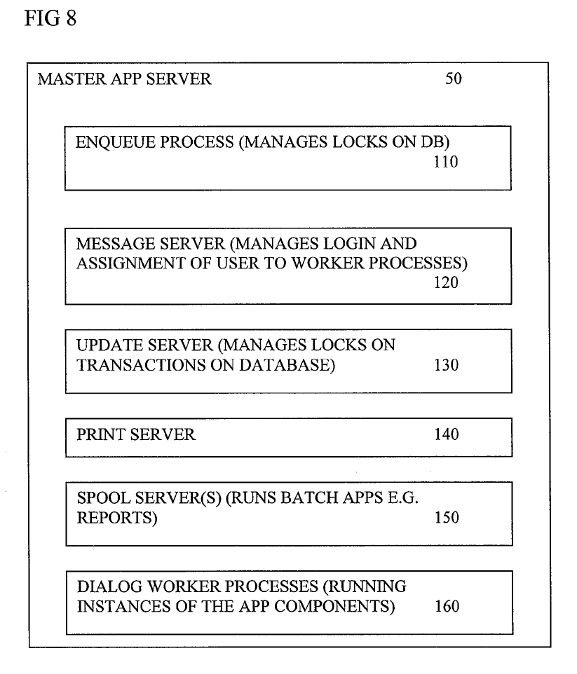

“ApplicationExecutionService” means a service which can manage the execution of ApplicationExecutionComponents such as Work Processes, servlets or data-base processes. An example would be an Application Server as provided by SAP. Such an application server includes the collection of dialog work processes and other processes such as update and enqueue processes as shown in the diagram of the master application server. (FIG. 8).

“Application Packaging Model” is any model which describes the internal structure of the software: what products are needed and what modules are required from the product, and is typically contained by an unbound model.

“Application Performance Model” means any model which has the purpose of defining the resource demands, direct and indirect, for each Business process (BP) step. It can be contained in the unbound model.

“Component Performance Model” can mean any model containing the generic performance characteristics for an Application Component. This can be used to derive the Application Performance Model (which can be contained in the unbound model), by using the specific Business process steps and data characteristics specified in the Custom Model together with constraints specified in the Application Constraints Model.

“Custom Model” means a customized general model of a business process to reflect specific business requirements.

“Deployed Model” means a bound model with the binding information for the management services running in the system.

“Candidate Grounded Model” can be an intermediate model that may be generated by a tool as it transforms the Unbound Model into the Grounded Model.

“Grounded Component” can contain the installation and configuration information for both Grounded Execution Components and Grounded Execution Services, as well as information about policies and start/stop dependencies.

“Grounded Execution Component” can be a representation in the Grounded Model of a (worker) process, thread or servlet that executes an Application Component.

“Grounded Execution Service” is a representation in the Grounded Model of the entity that manages the execution of execution components such as Work Processes, servlets or database processes.

“Infrastructure Capability Model” can be a catalogue of resources that can be configured by the utility such as different computer types and devices such as firewalls and load balancers.

MIF (Model Information Flow) is a collection of models used to manage a business process through its entire lifecycle.

The present invention can be applied to many areas, the embodiments described in detail can only cover some of those areas. It can encompass modeling dynamic or static systems, such as enterprise management systems, networked information technology systems, utility computing systems, systems for managing complex systems such as telecommunications networks, cellular networks, electric power grids, biological systems, medical systems, weather forecasting systems, financial analysis systems, search engines, and so on. The details modeled will generally depend on the use or purpose of the model. So a model of a computer system may represent components such as servers, processors, memory, network links, disks, each of which has associated attributes such as processor speed, storage capacity, disk response time and so on. Relationships between components, such as containment, connectivity, and so on can also be represented.

An object-oriented paradigm can be used, in which the system components are modeled using objects, and relationships between components of the system are modeled either as attributes of an object, or objects themselves. Other paradigms can be used, in which the model focuses on what the system does rather than how it operates, or describes how the system operates. A database paradigm may specify entities and relationships. Formal languages for system modeling include text based DMTF Common InformationModel (CIM), Varilog, NS, C++, C, SQL, or graphically expressed based schemes.

### Additional Features

Some examples of additional features for dependent claims are as follows:

A location of the dedicated hardware can be remote from the service provider and the interface can be arranged for remote management. This is useful to distribute the load away from resources at a service provider location, and to ease bandwidth and latency limitations, especially if the location of the dedicated hardware is at an enterprise premises or at a local trusted internet service provider of the enterprise.

The computing infrastructure can comprise virtualized entities. This is one way of increasing flexibility of allocation of resources, and thus enabling improved efficiency of use of the resources.

The model can incorporate redundant hardware capacity of suitable size to enable virtualized entities to be moved off their corresponding hardware components onto the redundant hardware while the process is still running. This redundancy would normally not need to be included in a model for deployment in a shared data centre as the data centre management would provide redundant capacity on a shared basis. Redundant capacity can also be used to support growth in loads or increases in loads due to changes in functional steps.

The system can have an update part arranged to enable the enterprise to input alterations to functional steps or non functional requirements, and to cause the model generation part to generate an updated model based on the alterations, and determine any changes in requirements for the dedicated hardware corresponding to the altered functional steps or non functional requirements.

The system can have a download part to download at least the model generation part to run at an enterprise location. This can help distribute the processing, to reduce the load on resources at the service provider, and can ease security concerns by enabling the enterprise to avoid sending sensitive data to the service provider for example.

The model can have a monitoring part to monitor behaviour of the deployed process in use and to send an indication of the behaviour through the interface to the service provider. This can enable the service provider to monitor the deployed process and take appropriate action. A basic level of service might involve reporting to the enterprise. A higher level of service could involve taking action to deal with infrastructure failures or routine upgrading. A yet higher level of service could involve analysing the behaviour and determine proposed changes to the model to improve a match of the computing infrastructure to the monitored behaviour. This could improve efficiency of use of resources or finding opportunities to improve flexibility to respond to time varying demands or changes to requirements for functional steps for example.

The model generation part can be arranged to select one of a number of predetermined templates of computing infrastructure design, choose parameters to fill the selected template, evaluate the filled template by simulating operation to see how well the non functional requirements are met, and alter the selection of template or alter the parameters according to the evaluation. This use of an infrastructure design template can reduce the number of options to be evaluated and can help reduce the complexity of the task of generating a model which can be deployed and which makes efficient use of resources. This in turn can help enable a more highly automated method, or can enable more complex business processes to be deployed more efficiently, and managed more efficiently. Where the infrastructure includes virtualized entities, the increased flexibility tends to increase the complexity of the task of infrastructure design, and the use of templates becomes even more appropriate and valuable in this case.

The system can have non functional requirements comprising any one or more of: a number of concurrent users, throughputs for functions, an indication of desired response time, an availability level, a security level, and limits of available dedicated hardware available. These are typically significant for the design of the computing infrastructure.

The system can be arranged to determine from the model a specification of requirements for the dedicated hardware. This can enable appropriate hardware to be set up ahead of the deployment. An alternative, encompassed by other claims, if the dedicated hardware is pre existing, would be to set limits on the performance required of the dedicated hardware in the non functional requirements. Then the model will be constrained to stay within such limits so that the model can be successfully deployed on the pre existing hardware.

Where a 3-D visual interface is provided with a game server to enable multiple users to work on the same model and see each others changes, developers can navigate complex models more quickly. Reference is made to above referenced copending application No. 200702356 for more details of examples of this. Combining this with using enterprise dedicated hardware with an interface to the service provider to enable ongoing management can enable such ongoing management to be provided more efficiently.

An enterprise interface can be provided to enable the enterprise to customise the non functional requirements independently of each other. Reference is made to above referenced copending application No. 200702363 for more details of examples of this. Combining this with using enterprise dedicated hardware with an interface to the service provider to enable ongoing management can enable more complete customisation to the enterprise's needs.

Where the operation of the business process can be simulated or where multiple test deployments can be made in parallel, development can be accelerated. Reference is made to above referenced copending application No. 200702377 for more details of examples of this. Combining this with using enterprise dedicated hardware with an interface to the service provider to enable ongoing management can enable the advantages of both to be enhanced.

Where annotations are inserted in the source code to assist in modeling or in documentation, then documenting the history of changes can be made easier. Reference is made to above referenced copending application No. 200702600 for more details of examples of this.

Setting up of a development environment can be facilitated by providing a predetermined mapping of which tools are appropriate for a given development purpose and given part of the model, or by including models of tools to be deployed with the model. Reference is made to above referenced copending application Nos. 200702145, and 200702601 for more details of examples of this. As the use of enterprise dedicated hardware with an interface to the service provider can add complexity to the setting up of the development environment, it is all the more valuable to facilitate such setting up.

### Model Based Approach

A general aim of this model based approach is to enable development and management of the business process to provide matched changes to three main layers: the functional steps of the process, the software application components used to implement the functional steps of the process, and configuration of the computing infrastructure used by the applications. Such changes are to be carried out automatically by use of appropriate software tools interacting with software models modeling the above mentioned parts. Until now there has not been any attempt to link together tools that integrate business process, application and infrastructure management through the entire system lifecycle.

A model-based approach for management of such complex computer based processes will be described. Such models can have structured data models in CIM/UML to model the following three layers:
Infrastructure elements, such as physical machines, VMs, network links.
Application elements, such as Databases, application servers.
Business level elements, such as functional steps of business processes running in the application servers.

A model is an organized collection of elements modeled in UML for example. A goal of some embodiments is to use these data models for the automated on-demand provision of enterprise applications following a Software as a service (SaaS) paradigm.

### Problem Statement

Using Model-Based technologies to automatically design and manage Enterprise Systems can offer powerful predictive power, and the capability to automatically design, deploy, modify, monitor, and manage a running system to implement a business process, while minimizing the requirement for human involvement.

The Enterprise System can be modeled at 4 interconnected layers:
Physical Infrastructure
Virtual Infrastructure
Software Landscape, corresponding to software entities such as the above mentioned application elements
Business Processes

This model is called the Enterprise System Model. At each layer, it consists of two sets of models—the Automation Model and the Document Model.
The Automation Model describes the structure and behaviour of the System, and is used to automatically generate, evaluate, deploy, and modify designs for Enterprise Systems. Monitored data from the deployed physical system at each of the 4 layers can be correlated with modeled behaviour and used to make run-time management decisions based on actual measurements.

The Automation Model is composed of two sub-models—the Static Model and an Operational Model. The Static Model describes the static structure of the system—the selection and configuration options of candidate designs of the Enterprise System. The Operational Model describes the internal structure, run-time operation, and performance demands (such as CPU, memory, disk, or network I/O) of the infrastructure and software. It is these Operational Models that allow simulation and evaluation of how well a candidate design will meet the non-functional requirements of the System.
The Document Model contains information that can be extracted and transformed into a valuable source of documentation of the System. The information that contributes to the Document Model may be closely associated with entities in the Automation Model. This documentation can be used by humans to understand and inspect the structure and operational behaviour of the system, both for functional correctness but also for non-functional behaviour such as performance. The documentation may also be used for training and educational purposes. Examples of documentation include:
UML diagrams of Business Process steps.
Descriptions of the function of Business Objects, their interfaces, and side effects.
UML diagrams of internal static structure of Software Applications, in terms of the constituent software components.
Activity diagrams of the interactions between software components.

The output from Monitoring and Reporting Services could also be classified as a special case of the Document Model, describing the run-time behaviour and performance of the system in human-readable form. Enterprise Systems are very complex, and the Models underlying the modeling techniques are correspondingly complex and difficult to create. The Models may change over time as systems are modified, patched and redesigned. Additionally, the models may depend on the actual data and configuration contained within a specific System and the observed behaviour of a running system.

In general, much of the detailed structure and parameters of the required models are too complex and dynamic for human beings to generate by hand in a timely fashion. The problem addressed by this invention is how to automatically generate, at least parts of, the Automation and Document Models. The information in the models must be consistent and correlated—activity in one part of the system must be traceable and correlated with related activities. For example, an activity A may result in a cascade of other activities B, C and D; it is desirable that these relationships can be represented at run-time and captured in the models.

Model-Based technologies to automatically design and manage Enterprise Systems—see “Adaptive Infrastructure meets Adaptive Applications”, by Brand et al, published as an external HP Labs Tech Report:

http://www.hpl.hp.com/techreports/2007/HPL-2007-138.html
and incorporated herein by reference, can provide the capability to automatically design, deploy, modify, monitor, and manage a running System to implement a business process, while minimizing the requirement for human involvement.

The embodiments are concerned with providing a mechanism to automatically generate key aspects of the required Automation Models of an Enterprise System, together with additional Document Models to be used by humans to understand and analyse the system.

Embodiments are concerned with configuring an enterprise application solution for an enterprise application computing appliance. This can involve accepting a customized description for an enterprise application system and deploying it to hardware (also called an appliance). The appliance can in some cases be specially designed using virtualization features to enable ongoing and remote management for the enterprise application and appliance and be tested for performance to verify that service levels requested are met. The appliance may operate on an enterprise premises or at an ISP of the enterprise's choosing for example. Enterprises want to have a choice whether to operate enterprise applications in shared environments or within an enterprise application appliance that operates at a location of their choice.

This approach provides choice for enterprises which want enterprise applications but prefer to outsource management, i.e., remote management coupled with on-site maintenance when necessary. Vendors providing an application appliance need to offer the right amount of capacity, too much or too little causes extra costs, the risk may prohibit the success of enterprise application appliances. An enterprise appliance that is verified to support the non-functional requirements of enterprises prior to delivery can lead to greater enterprise trust.

The use of virtualized infrastructure, e.g., with virtual machine migration, better support remote maintenance e.g., new hardware can be introduced and virtual machines migrated to it without shutting down the application e.g., new versions of software can be deployed and tested in the appliance prior to any upgrade of the operational software. Automatically deploying management services with enterprise application services can better enable consistent remote management and facilitate on-site maintenance when necessary.

Such model based configuration compares well to configuration done by hand, which can lead to differences in enterprise application environments which increases the complexity of remote management.

Infrastructure deployed by hand rather than being automated can mean the sizing method for particular parts of infrastructure, is ad hoc, increasing the risk of an incorrect amount of capacity in an appliance. Currently service providers only offer hosting in a shared environment even if an enterprise wants to operate an enterprise application appliance locally or in some other facility.

Some advantages which can arise include the following:

A customized solution can be provided via automation technologies rather than via scarce skilled human consultants. Enterprises can host solutions locally or at any location they desire thereby reducing dependency on wide area networks and application service providers. A combination of enterprise application services from multiple vendors can be provided on a single appliance. A combination or remote and on-site servicing can reduce the in house skills needed by enterprises to host their services locally. A single enterprise appliance places a less concentrated power and cooling burden on the public power grid than a large data center.

### EXAMPLE

### Operation of an Embodiment

A: Enterprise specifies requirements for system.
B: Design appropriate infrastructure to support the system and its management.
C: Render the infrastructure to an enterprise application appliance & deploy the enterprise and management services.
D: Affirm non-functional requirements are satisfied via testing.
E: Ship the enterprise appliance to enterprise.
F: Enterprise connects appliance to networks for use by users & for remote management.
G: Continuously apply remote and on-site management as appropriate, and implement changes in Enterprise requirements.

Step A: An enterprise uses one or more configuration tools to specify and configure a legal combination of enterprise application services. The enterprise application services may be offered by enterprise application service vendors, ISVs, (Internet Service Vendors) or be customizations that are tolerated by the overall framework presented in this application.

Configuration tools may be offered by enterprise application software vendors or ISVs and/or the enterprise application provider

Step B: designing a virtualized infrastructure for the enterprise application that can be hosted on an enterprise application appliance. Enterprise specifies non-functional requirements for the system and/or its services
E.g., performance, security, reliability, maintainability.

Design service recommends a configuration for an infrastructure design that supports the non-functional requirements for a particular enterprise application appliance. Infrastructure design includes support for firewalls, web servers, application servers, database servers, other kinds of servers, additional management software, hardware to support maintenance (i.e., roll over to a new version of software), it may include multiple servers and networking support.

Step C: render the application and management services to the virtualized infrastructure. A virtualized infrastructure is rendered to enterprise dedicated hardware in the form of an appropriately sized application appliance. This can be any size as appropriate to the needs of the business process, and in a typical example is a server or a rack of servers. Enterprise application and management services such as the remote management interface to the service provider are deployed to the infrastructure on the appliance.

Step D: validation tests are conducted to affirm support for non-functional requirements. Tests are conducted to ensure that each non-functional requirement is satisfied. If appropriate, tuning mechanisms are used to enable satisfaction of the requirements.

Step E: ship a configured appliance to an enterprise's desired location for the enterprise application appliance. The configured appliance is shipped to the enterprise's desired location for the enterprise application appliance. The location may be at the enterprise's site, at a hosting site chosen by the enterprise etc., it is any location deemed jointly acceptable to the enterprise and to the enterprise application appliance provider.

Step F: Enterprise need only turn on the appliance and connect it to networks for use by users. In all cases remote management services management and maintain the enterprise application appliance. In other embodiments the appliance is shipped first and configured remotely.

Step G: ongoing remote management/maintenance for the enterprise application and appliance. Remote maintenance can include support for:
Hardware and software failures
Software and hardware upgrades and additions
Security
Capacity planning
Database maintenance
Recognizing when on-site maintenance is needed and scheduling it On-site maintenance can include support for:
Hardware failure management and hardware upgrades
Services not successfully accomplished remotely

The enterprise may change the requirements for the system,—E.g., adding/removing services that are supported by the enterprise application appliance or modifying non-functional requirements. The impact of these changes is evaluated by remote management services and a combination or remote and, if required, on-site management actions are performed to implement the changes.

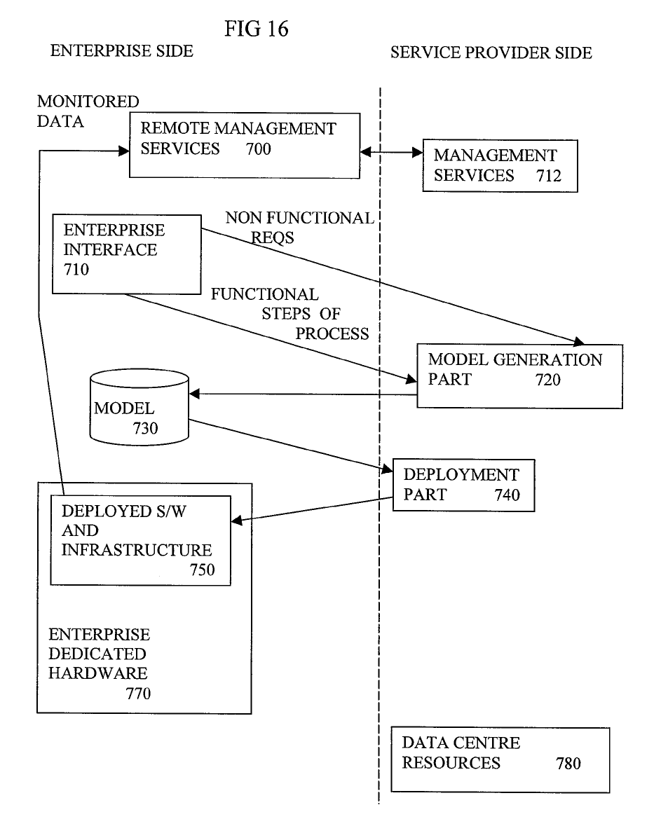

### FIGS. 16 to 21, Embodiments of the Invention

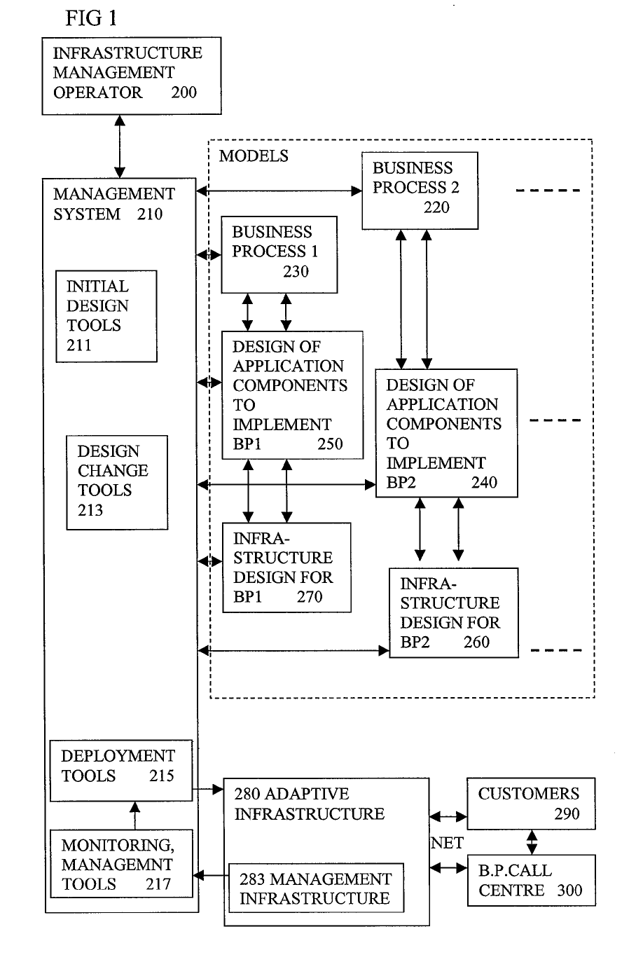

FIG. 16 shows some of the principal parts of an embodiment of the invention. It shows enterprise side items on the left side and service provider side items on the right side. An enterprise interface 710 is used to pass non functional requirements and functional steps of the desired business process to the service provider side. Here a model generation part 720 generates a model 730 of the business process. This can be stored at either the enterprise side or the service provider side. It may have a layered structure with an arrangement of software application components for implementing the functional steps, and a design of computing infrastructure for miming the software application components to meet the non functional requirements. More details of an implementation of the model generation part are shown below with reference to a model information flow and FIGS. 1 to 15. There is also shown in FIG. 16 a deployment part 740, located either at the enterprise or the service provider side. This creates a deployed business process 750 formed of the deployed modeled software application components and computing infrastructure. This is formed on enterprise dedicated hardware 770. Monitored data from the deployed business system can be fed back to a remote management services part 700. Management services 712 are provided in the service provider side to communicate with the enterprise side via the corresponding remote management services part 700. This provides an interface to enable the service provider to manage the activities at the enterprise side. The service provider side parts are typically software parts running on hardware in the form of shared data centre resources 780.

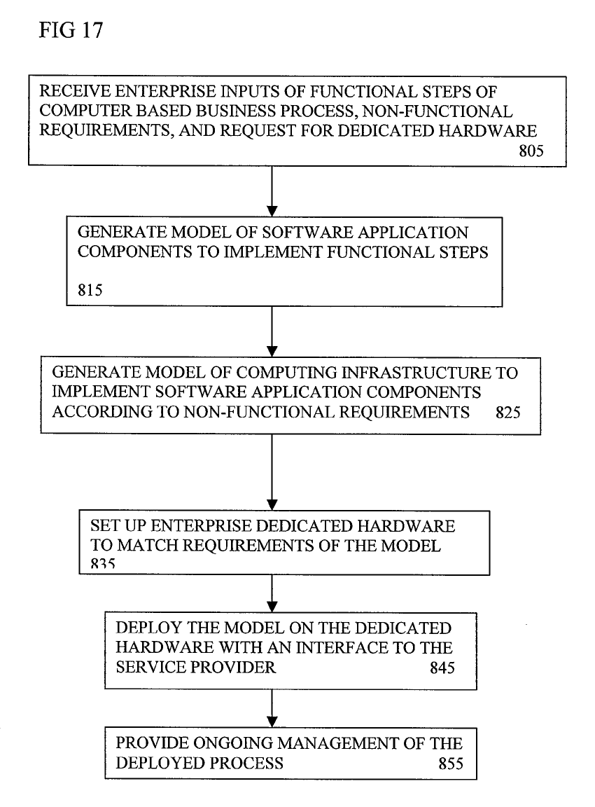

As shown in FIG. 17, an example of steps of the system of FIG. 16 in operation starts with receiving the inputs from the enterprise at step 805. This can include non functional requirements, and other items such as functional steps of the business process (or a choice of predetermined steps from a catalog for example), and a service level agreement if needed. At step 815 a model of software application components to implement the functional steps is generated by the model generation part. This can be implemented in various ways, and example is described in more detail with reference to FIGS. 1 to 15 below.

At step 825, a model of computing infrastructure for use in running the software application components is generated. This can be physical infrastructure, virtualised infrastructure, or commonly a mixture of both, some of the physical infrastructure for running the components and some for hosting the virtualised infrastructure. All is designed to meet the non functional requirements. The design may be semi automated in the sense of having an operator make decisions but being prompted and guided by design service software, such as the design template approach described in more detail below. At step 835, the enterprise dedicated hardware is set up to match the requirements of the model. At step 845 the model is deployed on physical infrastructure, complete with an interface to the service provider. This helps enable ongoing management of the deployed process, provided at step 855.

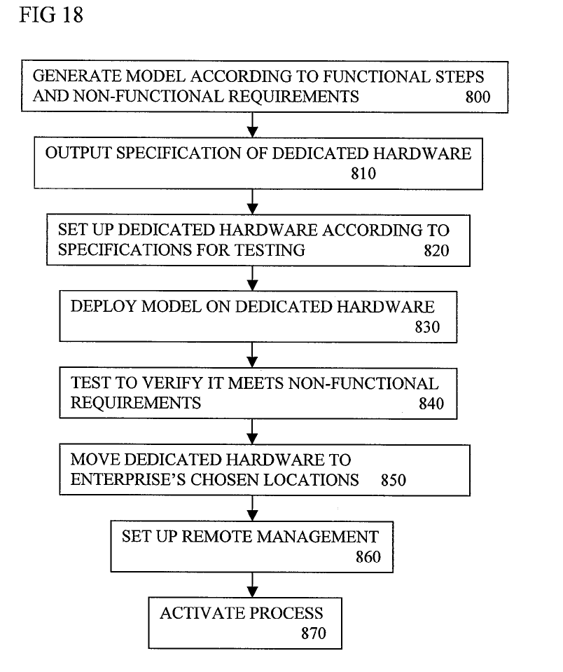

FIG. 18 shows steps according to another embodiment, with testing. At step 800 a model is generated according to functional steps and non functional requirements. A specification of the dedicated hardware is preferably generated and output at step 810. The hardware is set up for testing, according to the specification at step 820. The model is deployed on the dedicated hardware at step 830. It can be tested to verify it meets the non functional requirements at step 840. The dedicated hardware can be at the service provider's location for testing. If so, it after testing, having the business process deployed on it, it can be moved to the enterprise's chosen location at step 850. There, remote management should be set up at step 860, and the business process can be activated at step 870.

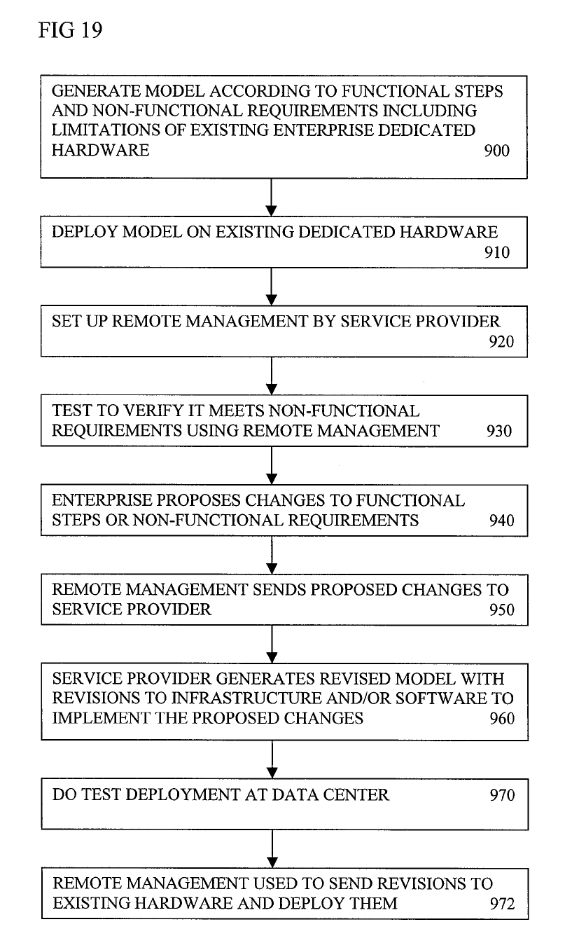

FIG. 19 shows steps according to another embodiment, for existing dedicated hardware. At step 900 a model is generated according to functional steps and non functional requirements, and according to limitations of existing enterprise dedicated hardware. The model is deployed on the existing dedicated hardware at step 910. Remote management can be set up at step 920. It can be tested to verify it meets the non functional requirements using the remote management part, at step 930. At step 940, the Enterprise proposes changes to functional steps or non functional requirements. These are passed to the model generation part. The service provider uses this part to generate a revised model with revisions to infrastructure design or software application components, to implement the proposed changes. A test deployment can be carried out at the data center at step 970, and the remote management parts be used to send the revisions and deploy them at step 972.

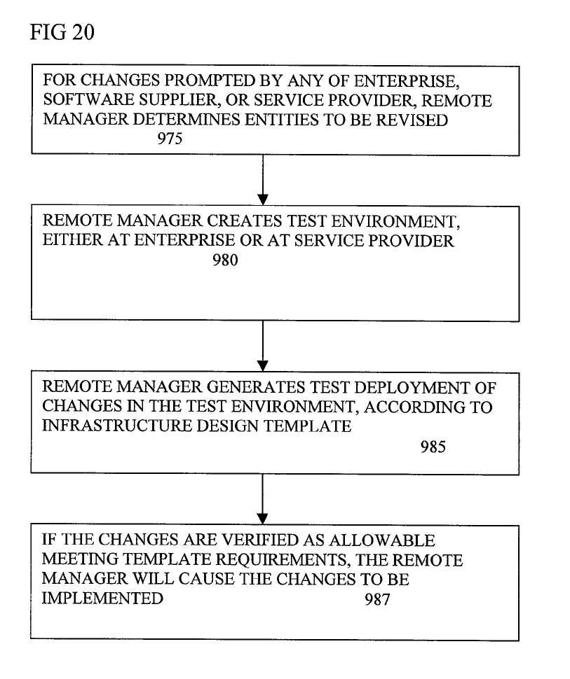

FIG. 20 shows another embodiment showing actions of an update part, which can be one part of the remote management services. For changes prompted by any party such as the enterprise, a software supplier, or the service provider, the update part determines which modeled entities should be revised at step 975. This can be parts in lower layers or higher layers of the model. The changes can be during development or during ongoing management of a live process. The update part creates a test environment either at the enterprise or at the service provider location. Possible ways of setting up test environments are shown in more detail in the above referenced copending cases '2145 and '2601. The update part generates at step 985 a test deployment of changes in the test environment, according to the infrastructure design template. If the changes are verified as allowable, meeting template requirements, the update part will cause the changes to be implemented at step 987.

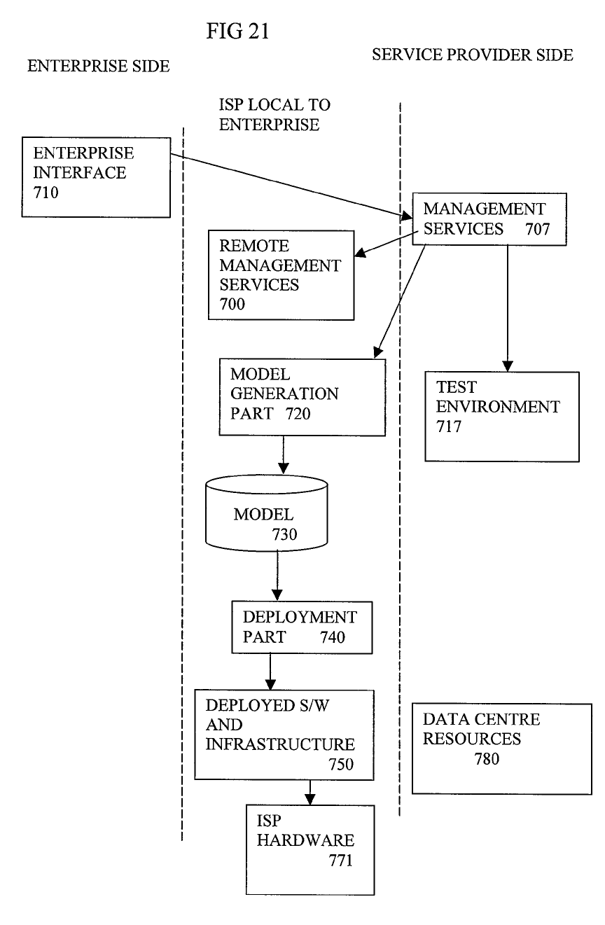

FIG. 21 shows another embodiment similar to that of FIG. 16. Similar reference numerals have been used as appropriate. In addition, some parts are located at an ISP (Internet Service Provider) local to the enterprise. In this view the parts located at the ISP are shown in the center of the figure. The enterprise interface is still at the enterprise. The remote management services, the model generation part, the model store, and the deployment part are located at the ISP, though they could be located elsewhere such as at the service provider location. The enterprise dedicated hardware is part of the ISP hardware 771. So the deployed business process 750 formed of the deployed modeled software application components and computing infrastructure is formed on the ISP hardware 771. Also shown here is a test environment 717, at the service provider's location so that ISP resources are not occupied by it.

### Source Content

The software of an enterprise application can be described by various kinds of Source Content. Typically the Source Content is owned by the enterprise application Vendor, who would also be responsible for adding the Model-Markup annotations. There may be several forms of Source Content such as:
Program Code written in languages such as Java, or ABAP. This code may be created directly by humans, or automatically generated from other Program Models or tools.
Program Models describe an aspect of the system, such as its static structure, or run-time behaviour. Program Models are themselves expressed in some form of mark-up language, such as XML. Examples might be:
State and Action diagrams for the behaviour of software components.
Business Process diagrams describing the set of business process steps.
Structure diagrams describing the static packaging of the software into deployable units, executables and products.

Program Code or Program Models may be generated via tools, such as graphical editors, or directly by humans. The syntax and language used to describe Source Content may vary widely.

### Model Information Flow

The resulting computational model can be used to automate the simulation, evaluation, and design of the system.

More details of an example of using a series of models for such purposes will now be described. If starting from scratch, a business process is designed using a business process modeling tool. The business process is selected from a catalog of available business processes and is customized by the business process modeling tool. An available business process is one that can be built and run. There will be corresponding templates for these as described below. Then non-functional characteristics such as reliability and performance requirements are specified.

Next the software entities such as products and components required to implement the business process are selected. This is done typically by searching through a catalog of product models in which the model for each product specifies what business process is implemented. This model is provided by an application expert or the product vendor.

Next the computing infrastructure such as virtual machines, operating systems, and underlying hardware, is designed. This can use templates as described in more detail below, and in above referenced previously filed application Ser. No. 11/741,878 “Using templates in automated model-based system design” incorporated herein by reference. A template is a model that has parameters and options, by filling in the parameters and selecting options a design tool transforms the template into a complete model of a deployable system. This application shows a method of modeling a business process having a number of computer implemented steps using software application components, to enable automatic deployment on a computing infrastructure, the method having the steps of:

automatically deriving a grounded model of the business process from an unbound model of the business process, the unbound model specifying the application components to be used for each of the computer implemented steps of the business process, without a complete design of the computing infrastructure, and the grounded model specifying a complete design of the computing infrastructure suitable for automatic deployment of the business process,

the deriving of the grounded model having the steps of providing an infrastructure design template having predetermined parts of the computing infrastructure, predetermined relationships between the parts, and having a limited number of options to be completed, generating a candidate grounded model by generating a completed candidate infrastructure design based on the infrastructure design template, and generating a candidate configuration of the software application components used by the unbound model, and evaluating the candidate grounded model, to determine if it can be used as the grounded model.

Next the physical resources from the shared resource pool in the data center are identified and allocated. Finally the physical resources are configured and deployed and ongoing management of the system can be carried out.

All of this can use SAP R/3 as an example, but is also applicable to other SAP systems or non-SAP systems. Template technology as described below can include not only the components needed to implement the business process and the management components required to manage that business process, but also designs for computing infrastructure.

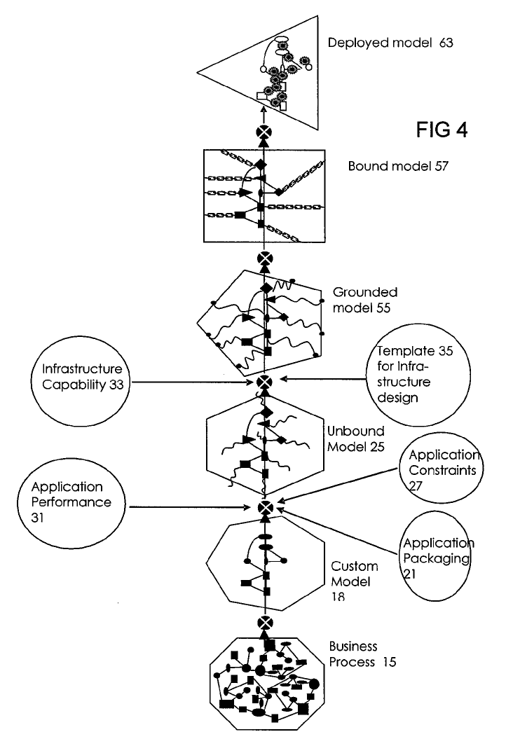

The model generation part can be implemented in various ways. One way is based on a six stage model flow called the Model Information Flow (MIF). This involves the model being developed in stages or phases which capture the lifecycle of the process from business requirements all the way to a complete running system. The six phases are shown in FIG. 4 described below and each has a corresponding type of model which can be summarised as follows:
General Model: The starting point, for example a high level description of business steps based on “out-of-the-box” functionalities of software packages the user can choose from, and the generic business processes and their constituent business process steps.
Custom Process Model: defined above and for example a specialization of the previous model (General Model) with choices made by the enterprise. This model captures non-functional requirements such as response time, throughput and levels of security. Additionally, it specifies modifications to the generic business processes for the enterprise. Additionally, it can specify modifications to the generic business processes for the enterprise.
Unbound Model: defined above, and for example an abstract logical description of the structure and behaviour of a system capable of running the business process with the requirements as specified by the enterprise.
Grounded Model: defined above and for example can be a transformation of the previous model (Unbound Model) to specify infrastructure choices, such as the quantities and types of hardware and virtualization techniques to use, and also the structure and configuration of the software to run the business process.
Bound Model: a grounded model for which resources in the data centre have been reserved.
Deployed Model: a grounded model where the infrastructure and the software components have been deployed and configured. At this point, the service is up and running.

Each stage of the flow has corresponding types of model which are stored in a Model Repository. Management services consume the models provided by the Model Repository and execute management actions to realize the transitions between phases, to generate the next model in the MIF. Those services can be for example:
Template-based Design Service (TDS) (and an example of a model based design service): translates non-functional requirements into design choices for a Grounded Model based on the template.
Resource Acquisition Service (RAS): its purpose is to allocate physical resources prior to the deployment of virtual resources, such as vms.
Resource Configuration Service (RCS): its role is to create/update the virtual infrastructure.
Software Deployment Service (SDS): installs and configures the applications needed to run the business processes, and potentially other software.
Monitoring Services (MS) deploys Probes to monitor behaviour of a Deployed Model. This can include monitoring at any one or more of these three levels:
   Infrastructure: e.g. to monitor CPU, RAM, network I/O usage regardless of which application or functional step is executing.
   Application: e.g. to monitor time taken or CPU consumption of a given application such as a DB process on the operating system, regardless of which particular infrastructure component is used.
   Business process: e.g. count the number of sales order per hour, regardless of which infrastructure components or applications are used.

### Templates for the Computing Infrastructure Design

Templates are used to capture designs that are known to instantiate successfully (using the management services mentioned above). An example of template describes a SAP module running on a Linux virtual machine (vm) with a certain amount of memory. The templates also capture management operations that it is known can be executed, for instance migration of vm of a certain kind, increasing the memory of a vm, deploying additional application server to respond to high load, etc . . . If a change management service refers to the templates, then the templates can be used to restrict the types of change (deltas) that can be applied to the models.

Templates sometimes have been used in specific tools to restrict choices. Another approach is to use constraints which provide the tool and user more freedom. In this approach constraints or rules are specified that the solution must satisfy. One example might be that there has to be at least one application server and at least one database in the application configuration. These constraints on their own do not reduce the complexity sufficiently for typical business processes, because if there are few constraints, then there are a large number of possible designs (also called a large solution space). If there are a large number of constraints (needed to characterize a solution), then searching and resolving all the constraints is really hard—a huge solution space to explore. Also it will take a long time to find which of the constraints invalidates a given possible design from the large list of constraints.

Templates might also contain instructions for managing change. For example they can contain reconfiguration instructions that need to be issued to the application components to add a new virtual machine with a new slave application server.

The deriving of the grounded model can involve specifying all servers needed for the application components. This is part of the design of the adaptive infrastructure and one of the principal determinants of performance of the deployed business process. The template may limit the number or type of servers, to reduce the number of options, to reduce complexity of finding an optimised solution for example.

The deriving of the grounded model from the unbound model can involve specifying a mapping of each of the application components to a server. This is part of configuring the application components to suit the design of adaptive infrastructure. The template may limit the range of possible mappings, to reduce the number of options, to reduce complexity of finding an optimised solution for example.

The deriving of the grounded model from the Unbound Model can involve specifying a configuration of management infrastructure for monitoring of the deployed business process in use. This monitoring can be at one or more different levels, such as monitoring the software application components, or the underlying adaptive infrastructure, such as software operating systems, or processing hardware, storage or communications.

More than one grounded model can be derived, each for deployment of the same business process at different times. This can enable more efficient use of resources for business processes which have time varying demand for those resources for example. Which of the grounded models is deployed at a given time can be switched over any time duration, such as hourly, daily, nightly, weekly, monthly, seasonally and so on. The switching can be at predetermined times, or switching can be arranged according to monitored demand, detected changes in resources, such as hardware failures or any other factor.

Where the computing infrastructure has virtualized entities, the deriving of the grounded model can be arranged to specify one or more virtualized entities without indicating how the virtualised entities are hosted. It has now been appreciated that the models and the deriving of them can be simplified by hiding such hosting, since the hosting can involve arbitrary recursion, in the sense of a virtual entity being hosted by another virtual entity, itself hosted by another virtual entity and so on. The template can specify virtual entities, and map application components to such virtual entities, to limit the number of options to be selected, again to reduce complexity. Such templates will be simpler if they do not need to specify the hosting of the virtual entities. The hosting can be defined at some time before deployment, by a separate resource allocation service for example.

The grounded model can be converted to a bound model, by reserving resources in the adaptive infrastructure for deploying the bound model. At this point, the amount of resources needed is known, so it can be more efficient to reserve resources at this time than reserving earlier, though other possibilities can be conceived. If the grounded model is for a change in an existing deployment, the method can have the step of determining differences to the existing deployed model, and reserving only the additional resources needed.

The bound model can be deployed by installing and starting the application components of the bound model. This enables the business process to be used. If the grounded model is for a change in an existing deployment, the differences to the existing deployed model can be determined, and only the additional application components need be installed and started.

Two notable points in the modeling philosophy are the use of templates to present a finite catalogue of resources that can be instantiated, and not exposing the hosting relationship for virtualized resources. Either or both can help reduce the complexity of the models and thus enable more efficient processing of the models for deployment or changing after deployment.

Some embodiments can use an infrastructure capability model to present the possible types of resources that can be provided by a computing fabric. An instance of an infrastructure capability model contains one instance for each type of Computer System or Device that can be deployed and configured by the underlying utility computing fabric. Each time the utility deploys and configures one of these types, the configuration will always be the same. For a Computer System this can mean the following for example.

Same memory, CPU, Operating System

Same number of NICs with same I/O capacity

Same number of disks with the same characteristics

The templates can map the application components to computers, while the range of both application components and computers is allowed to vary. In addition the templates can also include some or all of the network design, including for example whether firewalls and subnets separate the computers in the solution. In embodiments described below in more detail, the Application Packaging Model together with the Custom Process Model show how the various application components can implement the business process, and are packaged within the Grounded Model.

The template selected can also be used to limit changes to the system, such as changes to the business process, changes to the application components, or changes to the infrastructure, or consequential changes from any of these. This can make the ongoing management of the adaptive infrastructure a more tractable computing problem, and therefore allow more automation and thus reduced costs. In some example templates certain properties have a range: for example 0 to n, or 2 to n. A change management tool (or wizard, or set of tools or wizards) only allows changes to be made to the system that are consistent with template. The template is used by this change management tool to compute the set of allowable changes, it only permits allowable changes. This can help avoid the above mentioned difficulties in computing differences between models of current and next state, if there are no templates to limit the otherwise almost infinite numbers of possible configurations.

Some of the advantages or consequences of these features are as follows:

1. Simplicity: by using templates it becomes computationally tractable to build a linked tool set to integrate business process, application and infrastructure design and management through the entire lifecycle of design, deployment and change.

2. By limiting the number of possible configurations of the adaptive infrastructure, the particular computing problem of having to compute the differences between earlier and later states of complex models is eased or avoided. This can help enable a management system for the adaptive infrastructure which can determine automatically how to evolve the system from an arbitrary existing state to an arbitrary desired changed state. Instead templates fix the set of allowable changes and are used as configuration for a change management tool.

3. The template models formally relate the business process, application components and infrastructure design. This means that designs, or changes, to any one of these can be made dependent on the others for example, so that designs or changes which are inconsistent with the others are avoided.

### FIG. 1 Overview

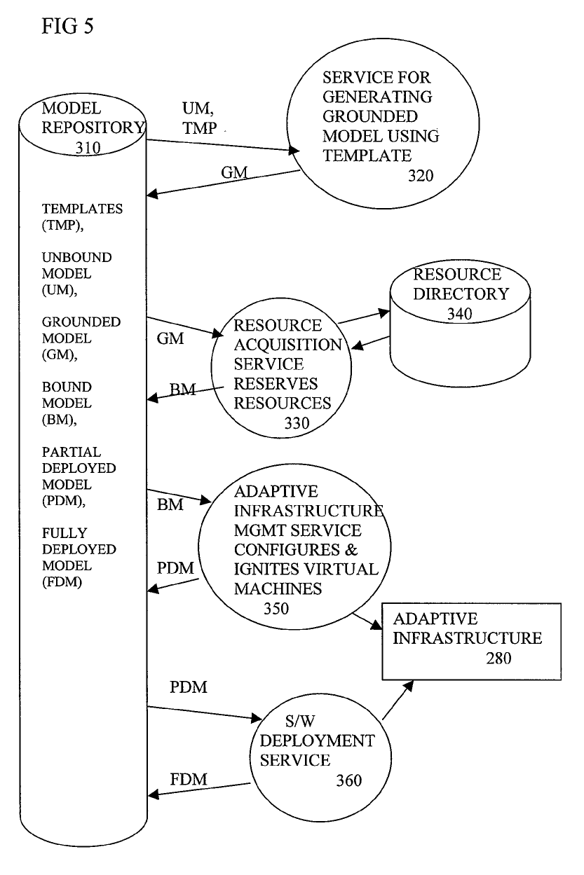

FIG. 1 shows an overview of infrastructure, applications, and management tools and models according to an embodiment. Adaptive infrastructure 280 is coupled typically over the internet to customers 290, optionally via a business process BP call centre 300. A management system 210 has tools and services for managing design and deployment and ongoing changes to deployed business processes, using a number of models. For example as shown, the management system has initial design tools 211, design change tools 213, deployment tools 215, and monitoring and management tools 217. These may be in the form of software tools running on conventional processing hardware, which may be distributed. Examples of initial design tools and design change tools are shown by the services illustrated in FIG. 5 described below.

A high level schematic view of some of the models are shown, for two business processes, there can be many more. Typically the management system belongs to a service provider, contracted to provide IT services to businesses who control their own business processes for their customers. A model 230 of business process 1 is used to develop a design 250 of software application components. This is used to create and infrastructure design 270 for running the application components to implement the business process. This design can then be deployed by the management system to run on the actual adaptive infrastructure, where it can be used for example by customers, a call centre and suppliers (not shown for clarity). Similarly, item 220 shows a model of a second business process, used to develop a design 240 of software application components. This is used to create and infrastructure design 260 for running the application components to implement the second business process. This design can then also be deployed by the management system to run on the actual adaptive infrastructure.

The management system has a visual interface to an infrastructure management operator 200, possibly with a 3D visual representation, as described in the corresponding copending application referenced above. This operator can be service provider staff, or in some cases can be trained staff of the business owning the process. The service provider staff may be able to view and manage the processes of different businesses deployed on the shared infrastructure. The operators of a given enterprise would be able to view and manage only their own processes. As discussed above, the interface can be coupled to the management system 210 to enable the operator to be able to interact with the various types of models, and with the infrastructure design template.

The adaptive infrastructure can include management infrastructure 283, for coupling to the monitoring and management tools 217 of the management system. The models need not be held all together in a single repository, in principle they can be stored anywhere.

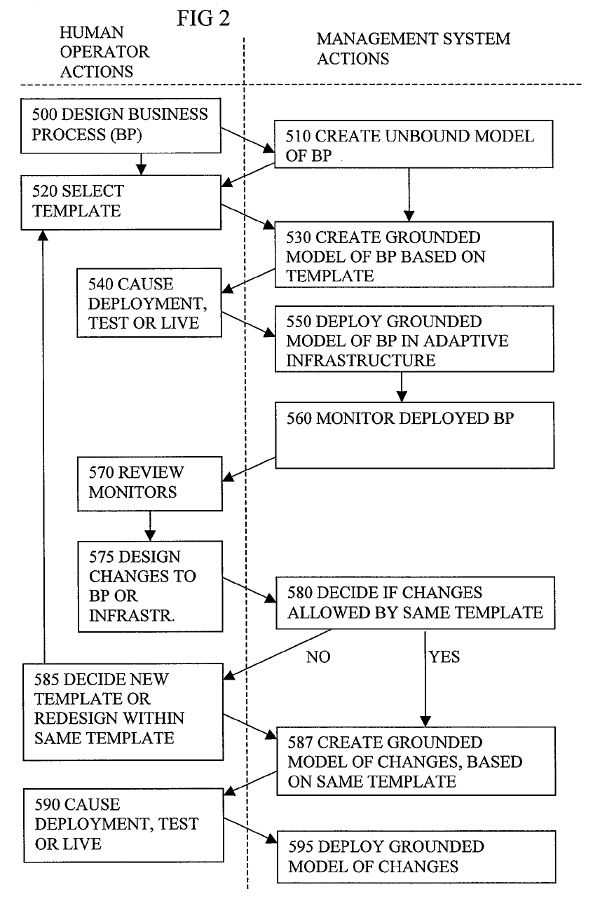

### FIG. 2 Operation

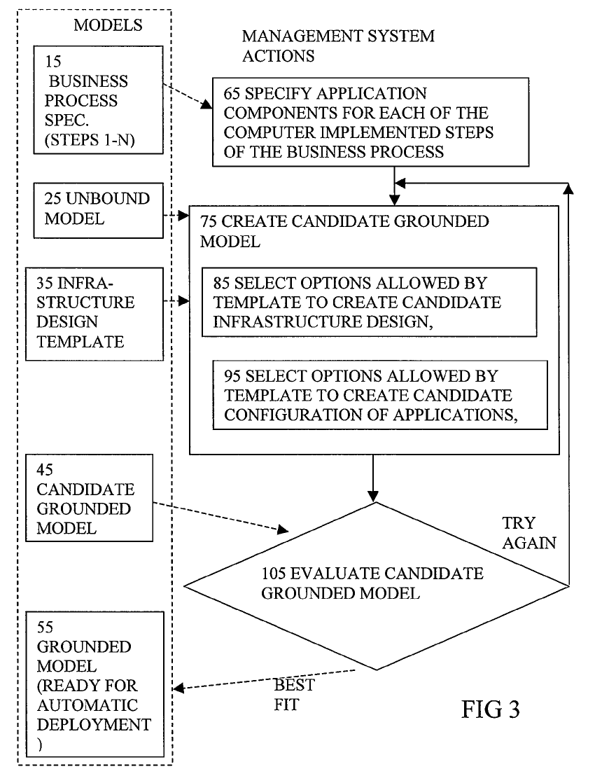

FIG. 2 shows a schematic view of some operation steps by an operator and by the management system, according to an embodiment. Human operator actions are shown in a left hand column, and actions of the management system are shown in the right hand column. At step 500 the human operator designs and inputs a business process (BP). At step 510 the management system creates an unbound model of the BP. At step 520, the operator selects a template for the design of the computing infrastructure. At step 530, the system uses the selected template to create a grounded model of the BP from the unbound model and the selected template. In principle the selection of the template might be automated or guided by the system. The human operator of the service provider then causes the grounded model to be deployed, either as a live business process with real customers, or as a test deployment under controlled or simulated conditions. The suitability of the grounded model can be evaluated before being deployed as a live business process, an example of how to do this is described below with reference to FIG. 3.

At step 550, the system deploys the grounded model of the BP in the adaptive infrastructure. The deployed BP is monitored by a monitoring means of any type, and monitoring results are passed to the human operator. Following review of the monitoring results at step 570, the operator of the enterprise can design changes to the BP or the operator of the service provider can design changes to the infrastructure at step 575. These are input to the system, and at step 580 the system decides if changes are allowed by the same template. If no, at step 585, the operator decides either for a new template, involving a return to step 520, or for a redesign within the limitations of the same template, involving at step 587 the system creating a grounded model of the changes, based on the same template.

At step 590 the operator of the service provider causes deployment of the grounded model for test or live deployment. At step 595 the system deploys the grounded model of the changes. In principle the changes could be derived later, by generating a complete grounded model, and later determining the differences, but this is likely to be more difficult.

### FIG. 3 Operation

FIG. 3 shows an overview of an embodiment showing some of the steps and models involved in taking a business process to automated deployment. These steps can be carried out by the management system of FIG. 1, or can be used in other embodiments.

A business process model 15 has a specification of steps 1-N. There can be many loops and conditional branches for example as is well known. It can be a mixture of human and computer implemented steps, the human input being by customers or suppliers or third parties for example. At step 65, application components are specified for each of the computer implemented steps of the business process. At step 75, a complete design of computing infrastructure is specified automatically, based on an unbound model 25. This can involve at step 85 taking an infrastructure design template 35, and selecting options allowed by the template to create a candidate infrastructure design. This can include design of software and hardware parts. At step 95, a candidate configuration of software application components allowed by the template is created, to fit the candidate infrastructure design. Together these form a candidate grounded model.

At step 105, the candidate grounded model is evaluated. If necessary, further candidate grounded models are created and evaluated. Which of the candidates is a best fit to the requirements of the business process and the available resources is identified. There are many possible ways of evaluating, and many possible criteria, which can be arranged to suit the type of business process. The criteria can be incorporated in the unbound model for example.

There can be several grounded models each for different times or different conditions. For example, time varying non-functional requirements can lead to different physical resources or even a reconfiguration: a VM might have memory removed out-of-office hours because fewer people will be using it. One might even shutdown an underused slave application server VM. The different grounded models would usually but not necessarily come from the same template with different parameters being applied to generate the different grounded models.

The template, grounded and subsequent models can contain configuration information for management infrastructure and instructions for the management infrastructure, for monitoring the business process when deployed. An example is placing monitors in each newly deployed virtual machine which raise alarms when the CPU utilization rises above a certain level—e.g. 60%.

### FIG. 4 MIF

FIG. 4 shows some of the principal elements of the MIF involved in the transition from a custom model to a deployed instance. For simplicity, it does not show the many cycles and iterations that would be involved in a typical application lifecycle—these can be assumed. The general model 15 of the business process is the starting point and it is assumed that a customer or consultant has designed a customized business process. That can be represented in various ways, so a preliminary step in many embodiments is customising it. A custom model 18 is a customization of a general model. So it is likely that a General Model could be modeled using techniques similar to the ones demonstrated for modeling the Custom Model: there would be different business process steps. A custom model differs from the general model in the following respects. It will include non-functional requirements such as number of users, response time, security and availability requirements. In addition it can optionally involve rearranging the business process steps: new branches, new loops, new steps, different/replacement steps, steps involving legacy or external systems.

The custom model is converted to an unbound model 25 with inputs such as application performance 31, application packaging 21, and application constraints 27. The unbound model can specify at least the application components to be used for each of the computer implemented steps of the business process, without a complete design of the computing infrastructure. The unbound model is converted to a grounded model 55 with input from models of infrastructure capability 33, and an infrastructure design template 35.

Deployment of the grounded model can involve conversion to a bound model 57, then conversion of the bound model to a deployed model 63. The bound model can have resources reserved, and the deployed model involves the applications being installed and started.

### FIG. 5 MIF

FIG. 5 shows a sequence of steps and models according to another embodiment. This shows a model repository 310 which can have models such as templates (TMP), an unbound model (UM), a bound model (BM), a partially deployed model (PDM), a fully deployed model (FDM). The figure also shows various services such as a service 320 for generating a grounded model from an unbound model using a template. Another service is a resource acquisition service 330 for reserving resources using a resources directory 340, to create a bound model.

An adaptive infrastructure management service 350 can configure and ignite virtual machines in the adaptive infrastructure 280, according to the bound model, to create a partially deployed model. Finally a software deployment service 360 can be used to take a partially deployed model and install and start application components to start the business process, and create a fully deployed model.

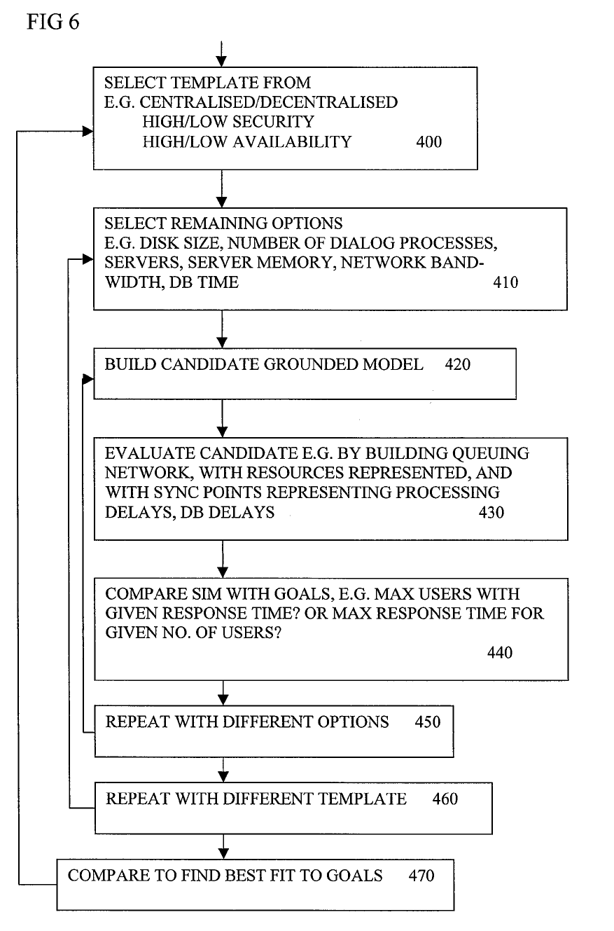

### FIG. 6 Deriving Grounded Model

FIG. 6 shows steps in deriving a grounded model according to an embodiment. At step 400, a template is selected from examples such as centralised or decentralised arrangements. A centralised arrangement implies all is hosted on a single server or virtual server. Other template choices may be for example high or low security, depending for example on what firewalls or other security features are provided. Other template choices may be for example high or low availability, which can imply redundancy being provided for some or all parts.

At step 410, remaining options in the selected template are filled in. This can involve selecting for example disk sizes, numbers of dialog processes, number of servers, server memory, network bandwidth, server memory, network bandwidth, database time allowed and so on. At step 420, a candidate grounded model is created by the selections. Step 430 involves evaluating the candidate grounded model e.g. by building a queuing network, with resources represented, and with sync points representing processing delays, db delays and so on. Alternatively the evaluation can involve deploying the model in an isolated network with simulated inputs and conditions.

At step 440, the evaluation or simulation results are compared with goals for the unbound model. These can be performance goals such as maximum number of simultaneous users with a given response time, or maximum response time, for a given number of users. At step 450, another candidate grounded model can be created and tested with different options allowed by the template. At step 460 the process is repeated for one or more different templates. At step 470, results are compared to identify which candidate or candidates provides the best fit. More than one grounded model may be selected, if for example the goals or requirements are different at different times for example. In this case, the second or subsequent grounded model can be created in the form of changes to the first grounded model.

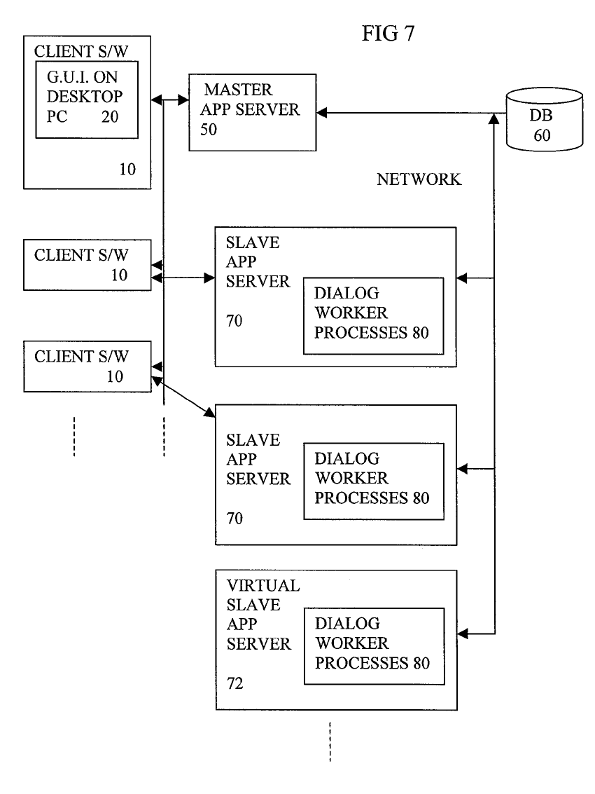

### FIG. 7 Master and Slave Application Servers

FIG. 7 shows an arrangement of master and slave application servers for a decentralised or distributed design of computing infrastructure, according to an embodiment. A master application server 50 is provided coupled by a network to a database 60, and to a number of slave application servers 70. Some of the slaves can be implemented as virtual slave application servers 72. Each slave can have a number of dialog worker processes 80. The master application server is also coupled to remote users using client software 10. These can each have a graphical user interface GUI on a desktop PC 20 coupled over the internet for example. The slaves can be used directly by the clients once the clients have logged on using the master.

### FIG. 8 Master Application Server

FIG. 8 shows parts of a master application server for the embodiment of FIG. 7. An enqueue process 110 is provided to manage locks on the database. A message server 120 is provided to manage login of users and assignment of users to slave application servers for example. An update server 130 is provided for managing committing work to persistent storage in a database. A print server 140 can be provided if needed. A spool server 150 can be provided to run batch tasks such as reports. At 160 dialog worker processes are shown for running instances of the application components.

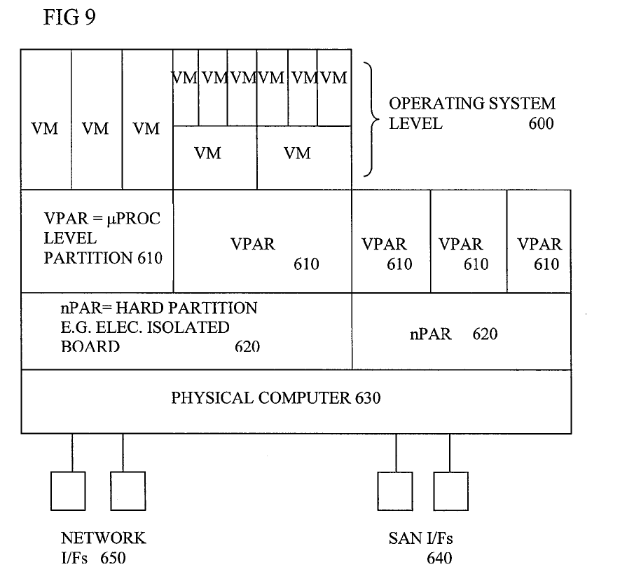

### FIG. 9 Virtual Entities

FIG. 9 shows an arrangement of virtual entities on a server, for use in an embodiment. A hierarchy of virtual entities is shown. At an operating system level there are many virtual machines VM. Some are hosted on other VMs. Some are hosted on virtual partitions VPARs 610 representing a reconfigurable partition of a hardware processing entity, for example by time sharing or by parallel processing circuitry. A number of these may be hosted by a hard partitioned entity nPAR 620 representing for example a circuit board mounting a number of the hardware processing entities. Multiple nPARs make up a physical computer 630 which is typically coupled to a network by network interface 650, and coupled to storage such as via a storage area network SAN interface 640.

There are many commercial storage virtualization products on the market from HP, IBM, EMC and others. These products are focused on managing the storage available to physical machines and increasing the utilization of storage. Virtual machine technology is a known mechanism to run operating system instances on one physical machine independently of other operating system instances. It is known, within a single physical machine, to have two virtual machines connected by a virtual network on this machine. VMware is a known example of virtual machine technology, and can provide isolated environments for different operating system instances running on the same physical machine.

There are also many levels at which virtualization can occur. For example HP's cellular architecture allows a single physical computer to be divided into a number of hard partitions or nPARs. Each nPAR appears to the operating system and applications as a separate physical machine. Similarly each nPAR can be divided into a number of virtual parititions or vPARs and each vPAR can be divided into a number of virtual machines (e.g. HPVM, Xen, VMware).

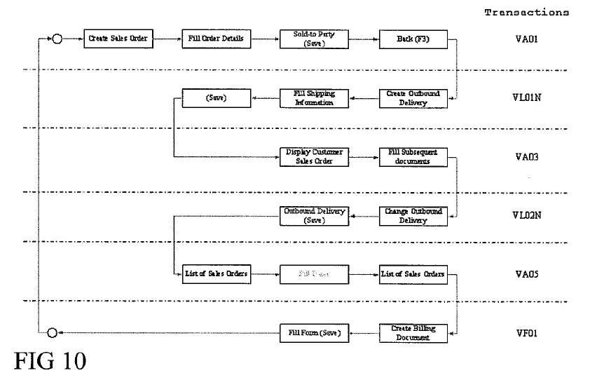

### FIGS. 10 to 15

The next part of this document describes in more detail with reference to FIGS. 10 to 15 examples of models that can be used within the Model Information Flow (MIF) shown in FIGS. 1 to 9, particularly FIG. 4. These models can be used to manage an SAP application or other business process through its entire lifecycle within a utility infrastructure. The diagrams are shown using the well known UML (Unified Modeling Language) that uses a CIM (common information model) style. The implementation can be in Java or other software languages.

A custom model can have a 1-1 correspondence between an instance of an AIService and a BusinessProcess. The AIService is the information service that implements the business process.

A business process can be decomposed into a number of business process steps (BPsteps), so instances of a BusinessProcess class can contain 1 or more BPSteps. An instance of a BPStep may be broken into multiple smaller BPSteps involving sequences, branches, recursions and loops for example. Once the BusinessProcess step is decomposed into sufficient detail, each of the lowest level BPSteps can be matched to an ApplicationComponent. An ApplicationComponent is the program or function that implements the BPStep. For SAP, an example would be the SAP transaction named VA01 in the SD (Sales and Distribution package) of SAP R/3 Enterprise. Another example could be a specific Web Service (running in an Application Server).

BPStep can have stepType and stepParams fields to describe not only execution and branching concepts like higher-level sequences of steps, but also the steps themselves. The stepType field is used to define sequential or parallel execution, loops, and if-then-else statements. The stepParams field is used to define associated data. For example, in the case of a loop, the stepParams field can be the loop count or a termination criterion. The set of BPSteps essentially describes a graph of steps with various controls such as loops, if-then-else statements, branching probabilities, etc.

The relation BPStepsToApplicationComponentMapping is a complex mapping that details how the BPStep is mapped to the ApplicationComponent. It represents, in a condensed form, a potentially complex mix of invocations on an Application Component by the BPStep, such as the specific dialog steps or functions invoked within the ApplicationComponent or set of method calls on a Web Service, and provided details of parameters, such as the average number of line items in a sales order.

A BPStep may have a set of non-functional requirements (NonFunctionalRequirements) associated with it: performance; availability, security and others. Availability and security requirements could be modeled by a string: “high”, “medium”, “low”. Performance requirements are specified in terms of for example a number of registered users (NoUsersReq), numbers of concurrent users of the system, the response time in seconds and throughput requirement for the number of transactions per second. Many BPSteps may share the same set of non-functional requirements. A time function can be denoted by a string. This specifies when the non-functional requirements apply, so different requirements can apply during office-hours to outside of normal office hours. Richer time varying functions are also possible to capture end of months peaks and the like.

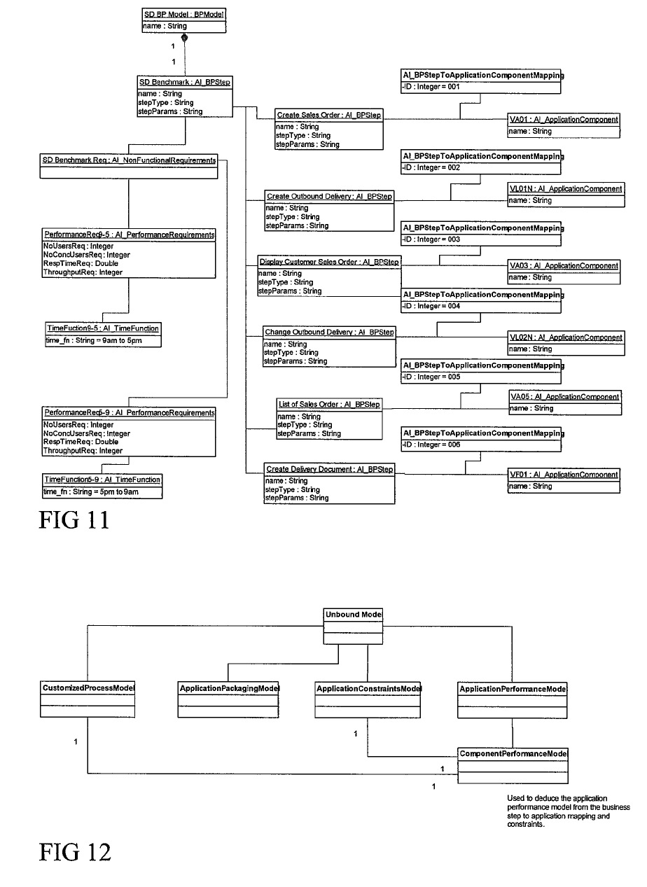

### FIGS. 10, 11 Custom Model

For an example of a Custom Model the well-known Sales and Distribution (SD) Benchmark will be discussed. This is software produced by the well known German company SAP. It is part of the SAP R/3 system, which is a collection of software that performs standard business functions for corporations, such as manufacturing, accounting, financial management, and human resources. The SAP R/3 system is a client server system able to run on virtually any hardware/software platform and able to use many different database management systems. For example it can use an IBM AS/400 server running operating system OS/400 using database system DB2; or a Sun Solaris (a dialect of Unix) using an Oracle database system; or an IBM PC running Windows NT using SQL Server.

SAP R/3 is designed to allow customers to choose their own set of business functions, and to customize to add new database entities or new functionality. The SD Benchmark simulates many concurrent users using the SD (Sales and Distribution) application to assess the performance capabilities of hardware. For each user the interaction consists of 16 separate steps (Dialog Steps) that are repeated over and over. The steps and their mapping to SAP transactions are shown in FIG. 10. A transaction here is an example of an Application Component. Each transaction is shown as a number of boxes in a row. A first box in each row represents a user invoking the transaction e.g. by typing /nva01 to start transaction VA01. As shown in FIG. 10, transaction VA01 in the top row involves the business process steps of invoking the create sales order transaction, then filling order details, then saving the sold-to party, and completing with the “back” function F3 which saves the data.

A next transaction VL01N is shown in the second row, and involves steps as follows to create an outbound delivery. The transaction is invoked, shipping information is filled in, and saved. A next transaction VA03 is shown in the third row for displaying a customer sales order. This involves invoking the transaction, and filling subsequent documents. A fourth transaction is VL02N in the fourth row, for changing an outbound delivery. After invoking this transaction, the next box shows saving the outbound delivery. A next transaction shown in the fifth row is VA05, for listing sales orders. After invoking this transaction, the next box shows prompting the user to fill in dates and then a third box shows listing sales orders for the given dates. Finally, in a sixth row, the transaction VF01 is for creating a billing document, and shows filling a form and saving the filled form.

FIG. 11 shows an example of a custom model instance for the SD Benchmark. The top two boxes indicate that the business process “BPModel” contains one top level BPStep: “SD Benchmark”, with stepType=Sequence. Two lines are shown leading from this box, one to the non-functional requirements associated with this top-level BPStep, and shown by the boxes at the left hand side. In this particular case only performance requirements have been specified—one for 9 am-5 pm and the other for 5 pm-9 am. Other types of non-functional requirements not shown could include security or availability requirements for example. In each case the performance requirements such as number of users, number of concurrent users, response time required, and throughput required, can be specified as shown. These are only examples. other requirements can be specified to suit the type of business process. A box representing the respective time function is coupled to each performance requirement box as shown. One indicates 9 am to 5 pm, and the other indicates 5 pm to 9 am in this example.

On the right hand side a line leads from the SD Benchmark BPStep to the functional requirements shown as six BPSteps, with stepType=Step—one for each SAP transaction shown in FIG. 10 (VA01, VL01N, etc). For convenience the name of the first dialog step for each transaction shown in FIG. 10 is used as the name of the corresponding BPStep shown in FIG. 11 (“Create sales order”, “Create outbound delivery”, “Display customer sales order”, “Change outbound delivery”, “List sales order”, and “Create delivery document”). For each of these steps the BPStepToApplicationComponentMapping relation specifies the details of the dialog steps involved. For example in the case of CreateSalesOrder, FIG. 10 shows that the BPStepToApplicationComponentMapping needs to specify the following dialog steps are executed in order: “Create Sales Order”, “Fill Order Details”, “Sold to Party” and “Back”. In addition it might specify the number of line items needed for “Fill Order Details”. At the right hand side of the figure, each BP step is coupled to an instance of its corresponding ApplicationComponent via the respective mapping. So BPstep “Create Sales order” is coupled to ApplicationComponent VA01, via mapping having ID:001. BPstep “Create outbound delivery” is coupled to ApplicationComponent VL01N via mapping having 1D:002. BPstep “Display customer sales order” is coupled via mapping having ID:003 to ApplicationComponent VA03. BPstep “Change outbound delivery” is coupled via mapping having 1D:004 to ApplicationComponent VL02N. BPstep “List sales order” is coupled via mapping having 1D:005 to ApplicationComponent VA05. BPstep “Create delivery document” is coupled via mapping having 1D:006 to ApplicationComponent VF01.

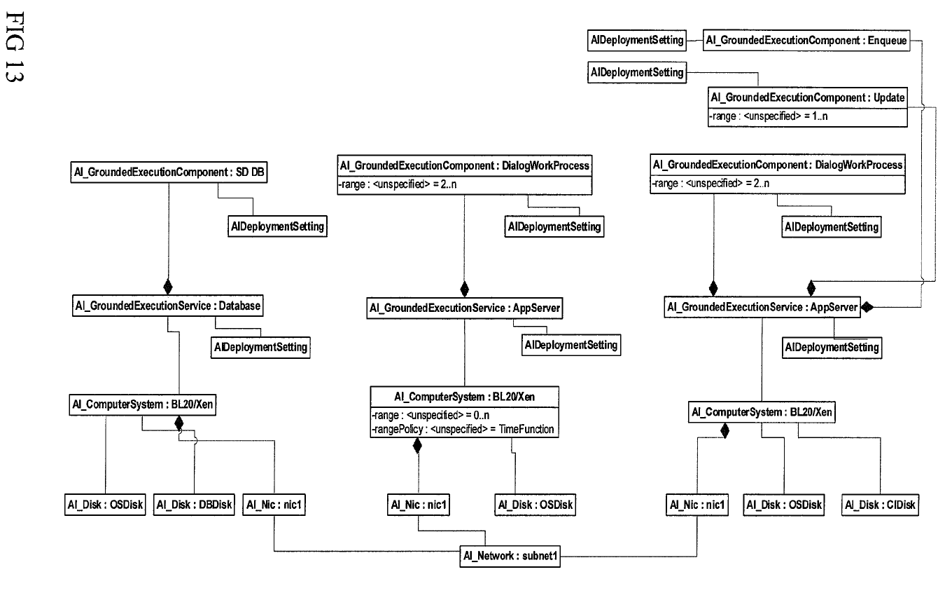

### FIG. 12, The Unbound Model

The Unbound Model is used to calculate resource demands. As shown in FIG. 12 this model can be made up of four models: the Custom Model (labelled CustomizedProcessingModel), Application Packaging, Application Constraints and Application Performance models, an example of each of which will be described below (other than the Custom Model, an example of which has been described above with respect to FIG. 11). Other arrangements can be envisaged. No new information is introduced that is not already contained in these four models.

### FIG. 12, Application Packaging Model

The Application Packaging Model describes the internal structure of the software: what products are needed and what modules are required from the product. An ApplicationComponent can be contained in an ApplicationModule. An ApplicationModule might correspond to a JAR (Java archive) file for an application server, or a table in a database. In the case of SAP it might be the module to be loaded from a specific product into an application server such as SD or FI (Financials). The application packaging model can have a DiskFootPrint to indicate the amount of disk storage required by the ApplicationModule. In the case of the ApplicationComponent VA01 in FIG. 10, it is from SD with a DiskFootPrint of 2 MB for example.

One or more ApplicationModules are contained within a product. So for example SAP R/3 Enterprise contains SD. ApplicationModules can be dependent on other ApplicationModules. For example the SD Code for the Application Server depends on both the SD Data and the SD Executable code being loaded into the database. The Application Packaging Model shows the ApplicationExecutionComponent that executes an ApplicationComponent. This could be a servlet running in an application server or a web server. It could also be a thread of a specific component or a process. In the case of SD's VAO1 transaction it is a Dialog Work Process. When it executes, the ApplicationComponent may indirectly use or invoke other Application-Components to run: a servlet may need to access a database process; SD transactions need to access other ApplicationComponents such as the Enqueue Work Process and the Update Work Process, as well as the Database ApplicationExecutionComponent.

The ApplicationExecutionComponent can be contained by and executed in the context of an ApplicationExecutionService (SAP application server) which loads or contains ApplicationModules (SD) and manages the execution of ApplicationExecutionComponents (Dialog WP) which, in turn, execute the ApplicationComponent (VA01) to deliver a BPStep.

### FIG. 12, Application Constraints Model

The Application Constraints Model expresses arbitrary constraints on components in the Customized Process, Application Packaging and Component Performance Models. These constraints are used by tools to generate additional models as the MIF progresses from left to right. Examples of constraints include:
How to scale up an application server—what ApplicationExecutionComponents are replicated and what are not. For example, to scale up an SAP application server to deal with more users one cannot simply replicate the first instance—the master application server 50 of FIGS. 7 and 8, commonly known as the Central Instance. Instead a subset of the components within the Central Instance is needed. This is also an example of design practice, there may be other constraints encoding best design practice.
Installation and configuration information for ApplicationComponents, ApplicationExecutionComponents and ApplicationExecutionServices
Performance constraints on ApplicationExecutionServices—e.g. do not run an application server on a machine with greater than 60% CPU utilization Other examples of constraints include ordering: the database needs to be started before the application server. Further constraints might be used to encode deployment and configuration information. The constraints can be contained all in the templates, or provided in addition to the templates, to further limit the number of options for the grounded model.

### FIG. 12, Application Performance Model

The purpose of the Application Performance Model is to define the resource demands for each BPStep. There are two types of resource demand to consider.
1. The demand for resources generated directly by the ApplicationExecutionComponent (e.g. Dialog WP) using CPU, storage I/O, network I/O and memory when it executes the BPStep—the ComponentResourceDemand
2. The demand for resources generated by components that the above ApplicationExecutionComponent causes when it uses, calls or invokes other components (e.g. a Dialog WP using an Update WP)—the IndirectComponentResourceDemand

The IndirectComponentResourceDemand is recursive. So there will be a tree like a call-graph or activity-graph.

A complete Application Performance Model would contain similar information for all the BPSteps shown in FIG. 11. For example the set of dialog steps in the BPStep “Create Sales Order” might consume 0.2 SAPS. Further it consists of 4 separate invocations (or in SAP terminology Dialog Steps). The calls are synchronous.

The following are some examples of attributes that can appear in IndirectComponentResourceDemands and ComponentResourceDemands.
delayProperties: Any delay (e.g. wait or sleep) associated with the component's activity which does not consume any CPU, NetIOProperties and DiskIOProperties.
NumInvocation: The number of times the component is called during the execution of the BPStep.
InvocationType: synchronous if the caller is blocked; asynchronous if the caller can immediately continue activity.
BPStepToAppCompID: This is the ID attribute of the BPStepToApplicationComponentMapping. The reason for this is that a particular ApplicationExecutionComponent is likely to be involved in several different BPSteps.
ApplicationEntryPoint: This is the program or function being executed. In the case of “Create Sales Order” this VA01 for the DialogWP. It could also be a method of a Web Service.
   CPUProperties can be expressed in SAPs or in other units. There are various ways to express MemProperties, NetIOProperties and DiskIOProperties.

### FIG. 12, Component Performance Model

There is one instance of an Application Performance Model for each instance of a Custom Model. This is because, in the general case, each business process will have unique characteristics: a unique ordering of BPSteps and/or a unique set of data characteristics for each BPStep. The DirectComponentResourceDemands and IndirectComponentResourceDemands associations specify the unique resource demands for each BPStep. These demands need to be calculated from known characteristics of each ApplicationComponent derived from benchmarks and also traces of installed systems.

The Component Performance Model contains known performance characteristics of each ApplicationComponent. A specific Application Performance Model is calculated by combining the following:
The information contained in the BPStepToApplicationComponentMapping associations in the Custom Model
Any performance related constraints in the Application Constraints Model
The Component Performance Model Taken together, the models of the Unbound Model specify not only the non-functional requirements of a system, but also a recipe for how to generate and evaluate possible software and hardware configurations that meet those requirements. The generation of possible hardware configurations is constrained by the choice of infrastructure available from a specific Infrastructure Provider, using information in an Infrastructure Capability Model, and by the selected template.

A general principle that applies to deployable software elements described in the Unbound Model, such as the ApplicationExecutionComponent or ApplicationExecutionService, is that the model contains only the minimum number of instances of each type of element necessary to describe the structure of the application topology. For example, in the case of SD only a single instance of a Dialog Work Process ApplicationExecutionComponent associated with a single instance of an Application Server ApplicationExecutionService is needed in the Unbound Model to describe the myriad of possible ways of instantiating the grounded equivalents of both elements in the Grounded Model. It is the template and packaging information that determines exactly how these entities can be replicated and co-located.

### The Infrastructure Capability Model

As discussed above, two notable features of the modeling philosophy described are:

1. Present a template having a finite catalogue of resources that can be instantiated, so that there are a fixed and finite number of choices. For example, small-xen-vm 1-disk, medium-xen-vm 2-disk, large-xen-vm 3-disk, physical-hpux-machine etc. This makes the selection of resource type by any capacity planning tool simpler. It also makes the infrastructure management easier as there is less complexity in resource configuration—standard templates can be used.

2. Do not expose the hosting relationship for virtualized resources. The DMTF Virtualization System Profile models hosting relationship as a “HostedDependency” association. This does not seem to be required if there is only a need to model a finite number of resource types, so it does not appear in any of the models discussed here. This keeps the models simpler since there is no need to deal with arbitrary recursion. It does not mean that tools that process these models can't use the DMTF approach internally if that is convenient. It may well be convenient for a Resource Directory Service and Resource Assignment Service to use this relationship in their internal models.

An instance of an infrastructure capability model contains one instance for each type of ComputerSystem or Device that can be deployed and configured by the underlying utility computing fabric. Each time the utility deploys and configures one of these types the configuration will always be the same. For a ComputerSystem this means the following.
Same memory, CPU, Operating System
Same number of NICs with same I/O capacity
Same number of disks with the same characteristics

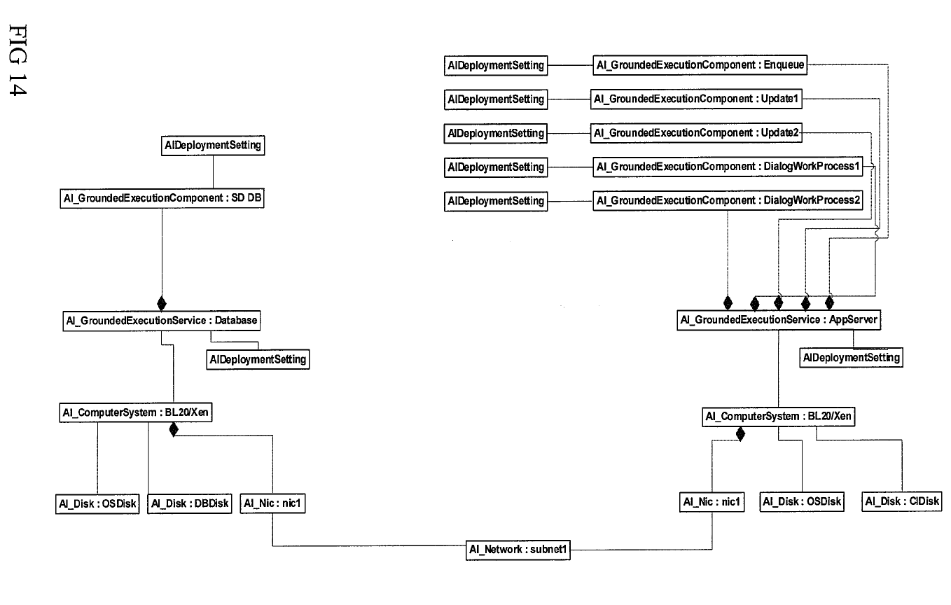

### FIG. 13 Template Example

FIG. 13 shows an example of an infrastructure design template having predetermined parts of the computing infrastructure, predetermined relationships between the parts, and having a limited number of options to be completed. In this case it is suitable for a decentralised SD business process, without security or availability features. The figure shows three computer systems coupled by a network labelled “AI_network”, the right hand of the three systems corresponding to a master application server, and the central one corresponds to slave application servers as shown in FIG. 7. Hence it is decentralized. AI is an abbreviation of Adaptive Infrastructure. The left hand one of the computer systems is for a database. The type of each computer system is specified, in this case as a BL20/Xen. The central one, corresponding to slave application servers has an attribute “range =0 . . . n”. This means the template allows any number of these slave application servers.

The master application server is coupled to a box labelled AI_GroundedExecutionService:AppServer, indicating it can be used to run such a software element. It has an associated AIDeploymentSetting box which contains configuration information and deployment information sufficient to allow the AI_GroundedExecutionService to be automatically installed, deployed and managed. The AI_GroundedExecutionService:AppServer is shown as containing three components, labelled AI_GroundedExecutionComponents, and each having an associated AIDeploymentSetting box. A first of these components is a dialog work process, for executing the application components of steps of the business process, another is an update process, responsible for committing work to persistent storage, and another is an enqueue process, for managing locks on a database. As shown, the range attribute is 2 . . . n for the update and the dialog work process, meaning multiple instances of these parts are allowed.

The slave application server has a GroundedExecutionService having only one type of AI_GroundedExecutionComponent for any number of dialog work processes. The slave application server is shown having a rangePolicy=Time function, meaning it is allowed to be active at given times. Again the service and the execution component each have an associated AIDeploymentSetting box.

The master and slave application servers and the database computer system have an operating system shown as AI_disk: OSDisk. The master application server is shown with an AI_Disk: CIDisk as storage for use by the application components. For the network, each computer system has a network interface shown as AI_Nic1, coupled to the network shown by AI_Network :subnet1.

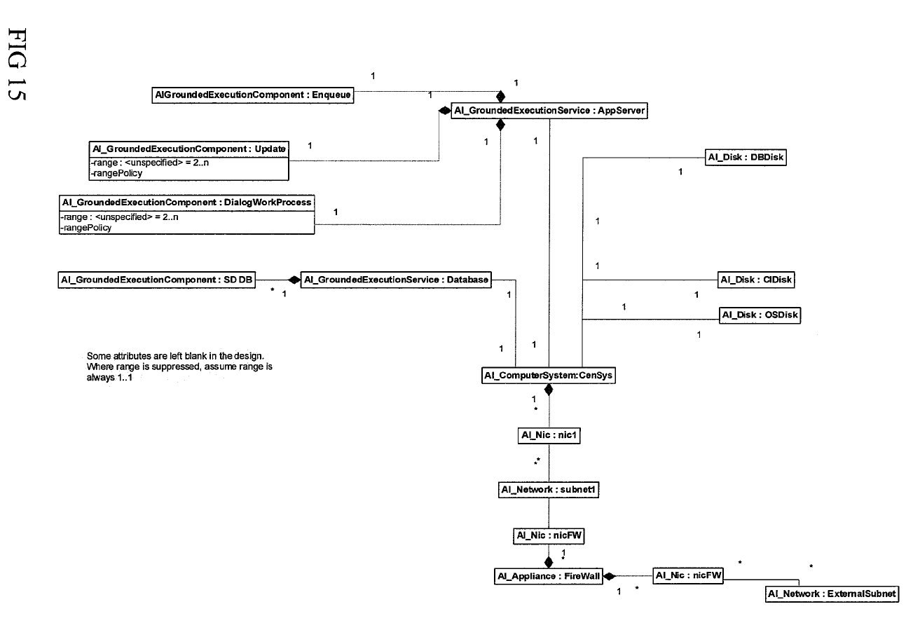

The database computer system is coupled to a box labelled AI_GroundedExecutionService: Database, which has only one type of AI_GroundedExecutionComponent, SD DB for the database. Again the service and the execution component each have an associated AIDeploymentSetting box. AIDeploymentSetting carries the configuration and management information used to deploy, configure, start, manage and change the component. Further details of an example of this are described below with reference to FIG. 14. This computer system is coupled to storage for the database labelled AI_Disk: DBDisk.

Optionally the template can have commands to be invoked by the tools, when generating the grounded model, or generating a changed grounded model to change an existing grounded model. Such commands can be arranged to limit the options available, and can use as inputs, parts of the template specifying some of the infrastructure design. They can also use parts of the unbound model as inputs.

### FIG. 14 Grounded Model

The Grounded Model may be generated by a design tool as it transforms the Unbound Model into the Grounded Model. It can be regarded as a candidate Grounded Model until evaluated and selected as the chosen Grounded Model. The following are some of the characteristics of the example Grounded Model of FIG. 14 compared to the template shown in FIG. 13, from which it is derived.
The number of instances of GroundedExecutionComponent has been specified.
The GroundedExecutionComponents are executed by a GroundedExecutionService. The execution relationship is consistent with that expressed in the Application Packaging Model.
The GroundedExecutionServices are run on a ComputerSystem whose type has been selected from the Infrastructure Capability Model.
There are two update components, Update1 and Update2. There are two DialogWorkProcesses, DialogWorkProcess1 and DialogWorkProcess2.
The number of slave application servers has been set at zero.

The management system is arranged to make these choices to derive the Grounded Model from the template using the Unbound Model. In the example shown, the criteria used for the choice includes the total capacity of the system, which must satisfy the time varying Performance Requirements in the Custom Model. The required capacity is determined by combining these Performance Requirements with the aggregated ResourceDemands [Direct and Indirect] of the Application Performance Model. If the first choice proves to provide too little capacity, or perhaps too much, then other choices can be made and evaluated. Other examples can have different criteria and different ways of evaluating how close the candidate grounded model is to being a best fit.

In some examples the server may only have an OS disk attached; that is because the convention in such installations is to NFS mount the CI disk to get its SAP executable files. Other example templates could have selectable details or options such as details of the CIDisk and the DBDisk being 100 GB, 20MB/sec, non Raid, and so on. The OS disks can be of type EVA800. The master and slave application servers can have 2 to 5 dialog work processes. Computer systems are specified as having 3 GB storage, 2.6 GHz CPUs and SLES 10-Xen operating system for example. Different parameters can be tried to form candidate Grounded Models which can be evaluated to find the best fit for the desired performance or capacity or other criteria.

The Grounded Model therefore specifies the precise number and types of required instances of software and hardware deployable entities, such as GroundedExecutionComponent, GroundedExecutionService, and AIComputerSystem. AIDeploymentSettings can include for example:
InfrastructureSettings such as threshold information for infrastructure management components, for example MaxCPUUtilization—if it rises above the set figure, say 60%, an alarm should be triggered.
Management policy can specify further policy information for the management components—e.g. flex up if utilization rises above 60%
GroundedDeploymentSettings which can include all command line and configuration information so that the system can be installed, configured and started in a fully functional state.
SettingData which can provide additional configuration information that can override information provided in the GroundedDeploymentSettings. This allows many GroundedComponents to share the same GroundedDeploymentSettings (c.f. a notion of typing) with specific parameters or overrides provided by SettingData. Both the GroundedDeploymentSettings and SettingData are interpreted by the Deployment Service during deployment.
Data related to possible changes to the component such as instructions to be carried out when managing changes to the component, to enable more automation of changes.

Not all attributes are set in the Grounded Model. For example, it does not make sense to set MAC addresses in the Grounded Model, since there is not yet any assigned physical resource.

### FIG. 15, An Alternative Adaptive Infrastructure Design Template

FIG. 15 shows an alternative adaptive infrastructure design template, in a form suitable for a centralised secure SD business process. Compared to FIG. 13, this has only one computer system, hence it is centralised. It shows security features in the form of a connection of the network to an external subnet via a firewall. This is shown by an interface AI_Nic:nicFW, and a firewall shown by AI_Appliance: FireWall.

Other templates can be envisaged having any configuration. Other examples can include a decentralised secure SD template, a decentralised highly available SD template, and a decentralised, secure and highly available SD template.

### Bound Model

A Bound Model Instance for a SD system example could have in addition to the physical resource assignment, other parameters set such as subnet masks and MAC addresses. A Deployed Model could differ from the Bound Model in only one respect. It shows the binding information for the management services running in the system. All the entities would have management infrastructure in the form of for example a management service. The implementation mechanism used for the interface to the management services is not defined here, but could be a reference to a Web Service or a SmartFrog component for example. The management service can be used to change state and observe the current state. Neither the state information made available by the management service, nor the operations performed by it, are necessarily defined in the core of the model, but can be defined in associated models.

One example of this could be to manage a virtual machine migration. The application managing the migration would use the management service running on the PhysicalComputerSystem to do the migration. Once the migration is completed, the management application would update the deployed model and bound models to show the new physical system. Care needs to be taken to maintain consistency of models. All previous model instances are kept in the model repository, so when the migration is complete, there would be a new instance (version) of the bound and deployed models.

### Information Hiding and the Model Information Flow

It is not always the case that for the MIF all tools and every actor can see all the information in the model. In particular it is not the case for deployment services having a security model which requires strong separation between actors. For example, there can be a very strong separation between a utility management plane and farms of virtual machines. If a grounded model is fed to the deployment services of the management plane by an enterprise, to deploy the model, it will not return any binding information showing the binding of virtual to physical machines, that will be kept inside the management plane. That means there is no way of telling to what hardware that farm is bound or what two farms might be sharing. What is returned from the management plane could include the IP address of the virtual machines in the farms (it only deals with virtual machines) and the login credentials for those machines in a given farm. The management plane is trusted to manage a farm so that it gets the requested resources. Once the deployment service has finished working, one could use application installation and management services to install, start and manage the applications. In general different tools will see projections of the MIF. It is possible to extract from the MIF models the information these tools require and populate the models with the results the tools return. It will be possible to transform between the MIF models and the data format that the various tools use.

### Implementation:

The software parts such as the models, the model repository, and the tools or services for manipulating the models, can be implemented using any conventional programming language, including languages such as Java, or C compiled following established practice. The servers and network elements can be implemented using conventional hardware with conventional processors. The processing elements need not be identical, but should be able to communicate with each other, e.g. by exchange of IP messages.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles behind the invention and its practical applications to enable one skilled in the art to utilize the invention in various embodiments and with various modifications as are suited to the particular use contemplated. Other variations can be conceived within the scope of the claims.

1. A method of automated deployment managed by a service provider, of a computer based business process having a number of functional steps, for a given enterprise, the method having the steps of:
generating a model of the business process, the model having a representation of an arrangement of software application components, for implementing the functional steps, and having a representation of computing infrastructure, for running the software application components on specified enterprise dedicated hardware, and suitable for automated deployment, and
deploying the model on the hardware dedicated to the enterprise, with an interface for the service provider to enable ongoing management of the deployed process by the service provider.

2. The method of claim 1, a location of the dedicated hardware being remote from the service provider and the interface being arranged for remote management.

3. The method of claim 2, the computing infrastructure comprising virtualized entities.

4. The method of claim 3, having the step of providing redundant hardware capacity, sized to enable virtualized entities of the modeled business process to be moved off their corresponding hardware components onto the redundant hardware while the deployed business process is still running.

5. The method of claim 2, having the step of receiving from the enterprise alterations to functional steps or non functional requirements, and generating an updated model based on the alterations, and determining any changes in requirements for the dedicated hardware corresponding to the alterations.

6. The method of claim 2, having the step of downloading at least the model generation part to run at an enterprise location.

7. The method of claim 1, having the step of monitoring behaviour of the deployed process in use and sending an indication of the behaviour through the interface to the service provider.

8. The method of claim 1, having the step of selecting one of a number of predetermined templates of computing infrastructure design, choosing parameters to fill the selected template, evaluating the filled template by simulating operation to see how well any non functional requirements are met, and altering the selection of template or altering the parameters according to the evaluation.

9. The method of claim 1 having the step of determining from the model a specification of requirements for the dedicated hardware.

10. Software on a machine readable medium which when executed carries out the method of claim 1.

11. A system, for automated deployment managed by a service provider, of a computer based business process having a number of functional steps, for a given enterprise, the system having:
a model generation part arranged to generate a model of the process, the model having a representation of an arrangement of software application components, for implementing the functional steps, and having a representation of computing infrastructure, for running the software application components on specified enterprise dedicated hardware, and suitable for automated deployment, and
a deployment part arranged to provide automated deployment of the model on the hardware dedicated to the enterprise, with an interface for the service provider to enable ongoing management of the deployed process by the service provider.

12. The system of claim 11, a location of the dedicated hardware being remote from the service provider and the interface being arranged for remote management.

13. The system of claim 12, the computing infrastructure comprising virtualized entities.

14. The system of claim 13, the model incorporating redundant hardware capacity to enable virtualized entities to be moved off their corresponding hardware components onto the redundant hardware while the process is still running.

15. The system of claim 12, having an update part arranged to enable the enterprise to input alterations to functional steps or non functional requirements, and to cause the model generation part to generate an updated model based on the alterations, and determine any changes in requirements for the dedicated hardware corresponding to the altered functional steps or non functional requirements.

16. The system of claim 12, having a download part to download at least the model generation part to run at an enterprise location.

17. The system of claim 11, the model being arranged to incorporate a monitoring part to monitor behaviour of the deployed process in use and to send an indication of the behaviour through the interface to the service provider.

18. The system of claim 11, the model generation part being arranged to select one of a number of predetermined templates of computing infrastructure design, choose parameters to fill the selected template, evaluate the filled template by simulating operation to see how well any non functional requirements are met, and alter the selection of template or alter the parameters according to the evaluation.

19. The system of claim 11 arranged to determine from the model a specification of requirements for the dedicated hardware.
